(19) United States
(12) Patent Application Publication
(10) Pub. No.: US 2025/0226959 A1
(43) Pub. Date: Jul. 10, 2025

(54) FEEDBACK FOR GROUPCAST TRANSMISSIONS IN PRESENCE OF ENERGY HARVESTING DEVICES

(71) Applicant: QUALCOMM Incorporated, San Diego, CA (US)

(72) Inventors: Ahmed ELSHAFIE, San Diego, CA (US); Seyedkianoush HOSSEINI, San Diego, CA (US); Yuchul KIM, San Diego, CA (US); Zhikun WU, Beijing (CN)

(21) Appl. No.: 18/853,709

(22) PCT Filed: May 10, 2022
(86) PCT No.: PCT/CN2022/091944

§ 371 Date: Oct. 2, 2024

(51) Int. Cl. H04L 5/00; H04W 72/20

(52) U.S. Cl. CPC H04L 5/0094; H04L 5/0055; H04W 72/20

(57) ABSTRACT

The apparatus may be configured to receive a groupcast transmission and transmit feedback for the groupcast transmission via a feedback resource in a set of feedback resources associated with the groupcast transmission, the feedback resource being based on a network node class of the UE (e.g., a network node). The apparatus may be configured to transmit a groupcast transmission for reception by one or more network nodes of a group of network nodes including different classes of network nodes and receive feedback for the groupcast transmission from the one or more network nodes in one or more feedback resources based on a corresponding network node class of the one or more network nodes.

### TECHNICAL FIELD

The present disclosure relates generally to communication systems, and more particularly, to allocating feedback resources for feedback.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and a first apparatus are provided. The first apparatus, in some aspects, may be configured to receive a groupcast transmission and transmit feedback for the groupcast transmission via a feedback resource in a set of feedback resources associated with the groupcast transmission, the feedback resource being based on a network node class of the UE (e.g., a network node).

In an aspect of the disclosure, a method, a computer-readable medium, and a second apparatus are provided. The second apparatus, in some aspects, may be configured to transmit a groupcast transmission for reception by one or more network nodes of a group of network nodes including different classes of network nodes and receive feedback for the groupcast transmission from the one or more network nodes in one or more feedback resources based on a corresponding network node class of the one or more network nodes.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is a diagram illustrating a basic structure for reporting sidelink feedback to a network entity (e.g., a base station).

FIG. 5 is a call flow diagram illustrating a groupcast transmission and associated feedback transmission based on a network node class.

FIG. 6A is a call flow diagram illustrating a groupcast transmission and associated retransmission request indication based on a network node class.

FIG. 6B is a diagram illustrating the operations of FIG. 6A in a timeline view.

FIG. 7 is a call flow diagram illustrating a groupcast transmission and associated feedback transmission based on a network node class for a first network entity transmitting a groupcast transmission to at least a network node.

FIG. 8 is a diagram illustrating a set of slots and sub-channels and a corresponding set of feedback resource pools.

FIG. 9A is a diagram illustrating a first configuration for disjoint feedback resource pools for different network node classes.

FIG. 9B is a diagram illustrating a first configuration for disjoint feedback resource pools for different network node classes.

FIG. 10 is a flowchart of a method of wireless communication.

FIG. 11 is a flowchart of a method of wireless communication.

FIG. 12 is a flowchart of a method of wireless communication.

FIG. 13 is a flowchart of a method of wireless communication.

FIG. 14 is a flowchart of a method of wireless communication.

FIG. 15 is a flowchart of a method of wireless communication.

FIG. 16 is a diagram illustrating an example of a hardware implementation for an apparatus.

FIG. 17 is a diagram illustrating an example of a hardware implementation for an apparatus.

FIG. 18 is a diagram illustrating an example of a hardware implementation for a network entity.

FIG. 19 illustrates an example resource diagram with PSFCH resources.

FIG. 20 illustrates first and second subsets of feedback resources corresponding to non-EH UEs and EH UEs respectively.

### DETAILED DESCRIPTION

In some aspects of wireless communication, groupcast or multicast transmissions may be transmitted by a network entity or network node for reception by one or more network nodes of a group of network nodes. The groupcast transmission may be transmitted via sidelink communication (e.g., V2X, a PC5 interface) or a downlink transmission (e.g., via a Uu interface). As an example, one UE may transmit a sidelink transmission, e.g., a physical sidelink shared channel (PSSCH), for reception by a group of multiple UEs. In another example, a base station may transmit a downlink transmission, e.g., a physical downlink shared channel (PDSCH), to a group of multiple UEs. In some aspects, feedback for a groupcast transmission may be configured as NACK-only feedback (e.g., groupcast option 1 in sidelink). For both sidelink and downlink groupcast transmissions, receiving network nodes may transmit feedback (HARQ feedback) via a same set of resources associated with the groupcast transmission. As an example, the feedback resources may be based on a groupcast ID and source ID associated with the groupcast transmission.

In some aspects, the groupcast may be transmitted to a group of network nodes that includes different types of network nodes, network nodes that support different capabilities, and/or different classes of network nodes. As an example of different types of network nodes, a first type of network node may be an energy harvesting UE or may be a UE in an energy harvesting mode, whereas a second type of network node may be a non-energy harvesting UE or may be a UE in a non-energy harvesting mode. If an energy harvesting UE has energy below a threshold level, the UE may not send feedback. In aspects using NACK-only feedback, there may be challenges distinguishing between a lack of NACK feedback based on a successful decoding of a groupcast transmission and a lack of NACK feedback based on a receiving network node not having sufficient energy (e.g., when operating in an energy harvesting mode of operation). Aspects presented herein enable a feedback from a set of network nodes not performing an energy harvesting operation (e.g., network nodes with sufficient energy to transmit groupcast feedback or legacy network nodes incapable of performing an energy harvesting operation) to be distinguished from feedback from a set of network nodes performing energy harvesting operations (e.g., associated with different battery levels).

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

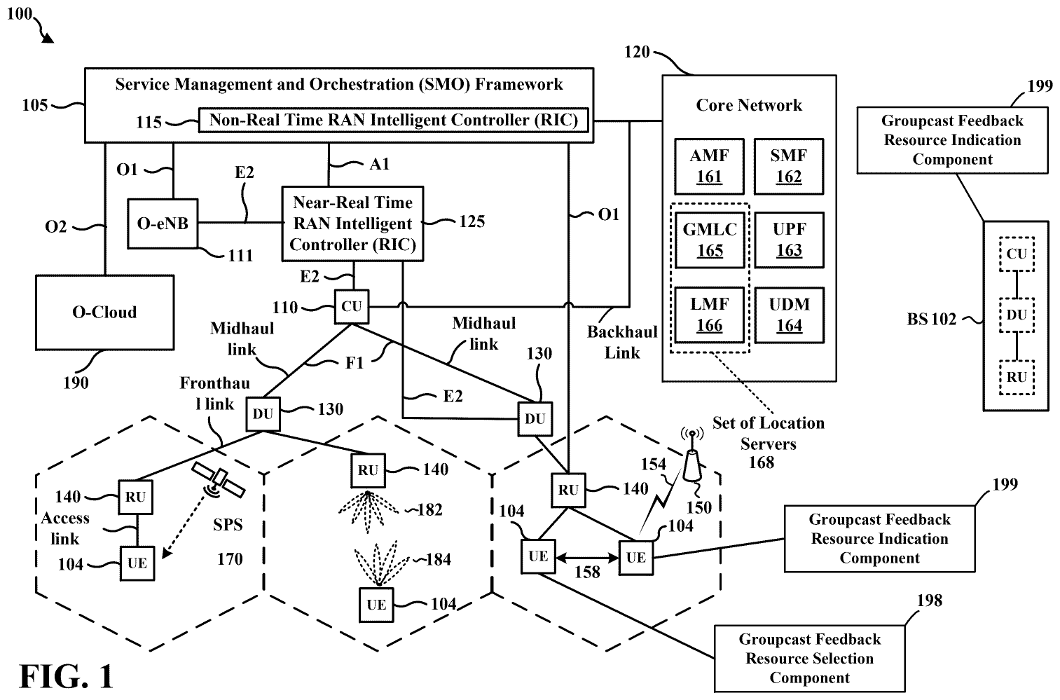

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include a groupcast feedback resource selection component 198 that may be configured to receive a groupcast transmission and transmit feedback for the groupcast transmission via a feedback resource in a set of feedback resources associated with the groupcast transmission, the feedback resource being based on a network node class of the UE (e.g., a network node). In certain aspects, the UE 104 may additionally, or alternatively, include a groupcast feedback resource indication component 199 that may be configured to transmit a groupcast transmission for reception by one or more network nodes of a group of network nodes including different classes of network nodes and receive feedback for the groupcast transmission from the one or more network nodes in one or more feedback resources based on a corresponding network node class of the one or more network nodes. In certain aspects, the base station 102 may include a groupcast feedback resource indication component 199 that may be configured to transmit a groupcast transmission for reception by one or more network nodes of a group of network nodes including different classes of network nodes and receive feedback for the groupcast transmission from the one or more network nodes in one or more feedback resources based on a corresponding network node class of the one or more network nodes. Although the following description may be focused on 5G NR, the concepts described herein may be applicable to other similar areas, such as LTE, LTE-A, CDMA, GSM, and other wireless technologies.

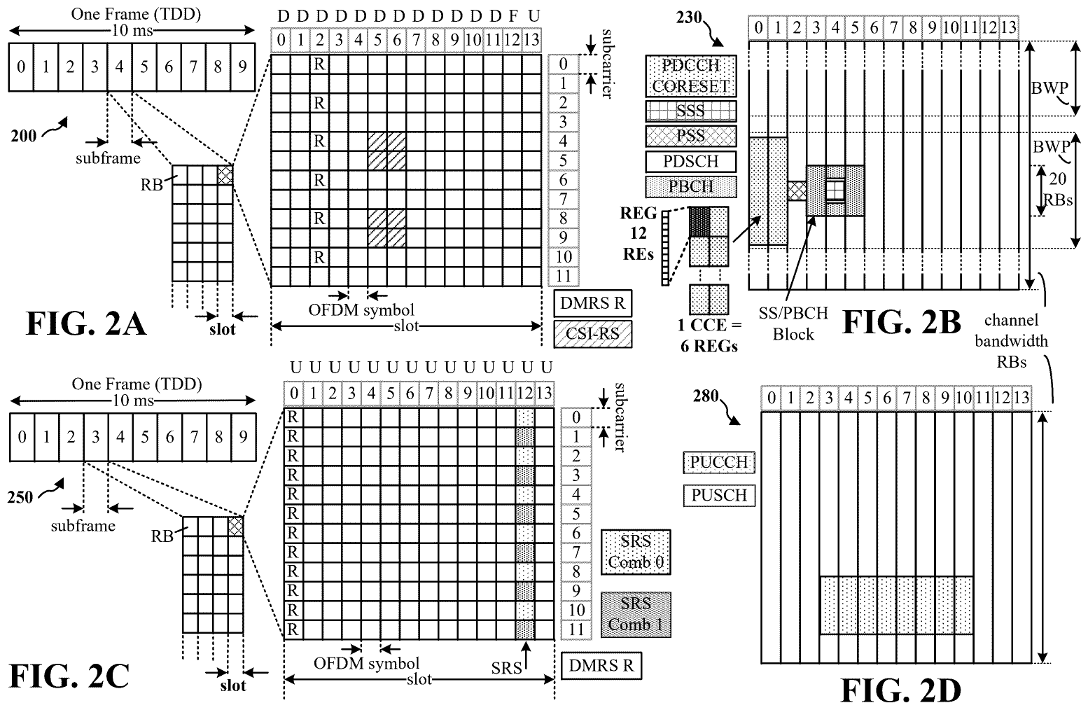

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology p, there are 14 symbols/slot and 2 slots/subframe. The subcarrier spacing may be equal to 2μ*15 kHz, where y is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

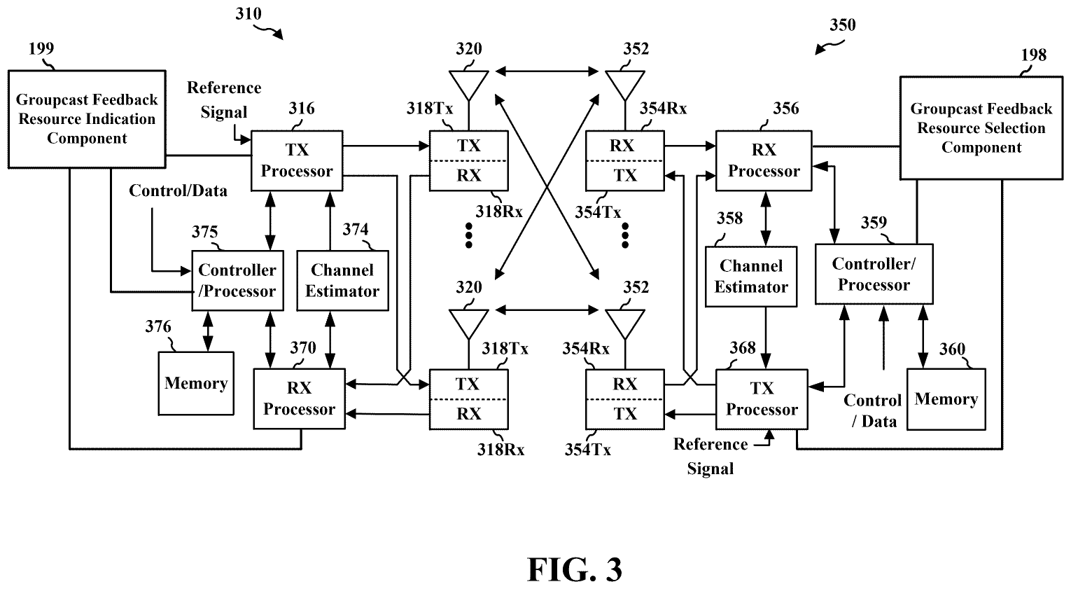

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the groupcast feedback resource selection component 198 of FIG. 1.

At least one of the TX processor 316, the RX processor 370, and the controller/processor 375 may be configured to perform aspects in connection with the groupcast feedback resource indication component 199 of FIG. 1.

In some aspects of wireless communication, groupcast or multicast transmissions may be transmitted by a network entity or network node for reception by one or more network nodes of a group of network nodes. The groupcast transmission may be transmitted via sidelink communication (e.g., V2X, a PC5 interface) or a downlink transmission (e.g., via a Uu interface). As an example, one UE may transmit a sidelink transmission, e.g., a PSSCH, for reception by a group of multiple UEs. In another example, a base station may transmit a downlink transmission, e.g., a PDSCH, to a group of multiple UEs. In some aspects, feedback for a groupcast transmission may be configured as NACK-only feedback (e.g., groupcast option 1 in sidelink). For both sidelink and downlink groupcast transmissions, receiving network nodes may transmit feedback (HARQ feedback) via a same set of resources associated with the groupcast transmission. As an example, the feedback resources may be based on a groupcast ID and source ID associated with the groupcast transmission.

In some aspects, the groupcast may be transmitted to a group of network nodes that includes different types of network nodes, network nodes that support different capabilities, and/or different classes of network nodes. As an example of different types of network nodes, a first type of network node may be an energy harvesting UE or may be a UE in an energy harvesting mode, whereas a second type of network node may be a non-energy harvesting UE or may be a UE in a non-energy harvesting mode. If an energy harvesting UE has energy below a threshold level, the UE may not send feedback. In aspects using NACK-only feedback, there may be challenges distinguishing between a lack of NACK feedback based on a successful decoding of a groupcast transmission and a lack of NACK feedback based on a receiving network node not having sufficient energy (e.g., when operating in an energy harvesting mode of operation). Aspects presented herein enable a feedback from a set of network nodes not performing an energy harvesting operation (e.g., network nodes with sufficient energy to transmit groupcast feedback or legacy network nodes incapable of performing an energy harvesting operation) to be distinguished from feedback from a set of network nodes performing energy harvesting operations (e.g., associated with different battery levels).

There is an increased interest in energy harvesting technology, e.g., for reduced capability (RedCap) or Passive internet of things (IoT) devices. Energy harvesting devices, in some aspects, may opportunistically harvest energy in the environment, such as solar, heat and ambient RF radiation and store the energy in a rechargeable battery. Accordingly, aspects presented herein provide protocol enhancements to support operation on intermittently available energy harvested from the environment. For energy harvesting operations, variations of an amount of harvested energy and an amount of traffic may be expected. Depending on the amount of harvested energy (e.g., an energy harvesting rate) and an amount of traffic (e.g., associated with an energy consumption rate) a device operating on intermittently available energy harvested from the environment may not sustain long continuous reception/transmission.

It will be understood that energy harvesting devices are not limited to a reduced capability devices, and the aspects presented herein are similarly applicable in non-reduced capability use cases. In contrast to backscatter communication based passive IoT devices, where a battery-less device collects energy from ambient RF signal and redirects energy to an RFID tag, an EH powered device may include power consuming RF components such as an analog to digital converter (ADC), mixer, and oscillators that use the harvested energy.

In some aspects, a common frequency resource (CFR) for multicast of RRC-CONNECTED UEs, may be confined within a frequency resource of a dedicated unicast BWP and may use the same numerology (SCS and CP). The CFR may be associated with one or more of a starting PRB and a number of PRBs, a PDSCH-config for multicast and broadcast services (MBS) (i.e., separate from the PDSCH-Config of the dedicated unicast BWP), a PDCCH-config for MBS (i.e., separate from the PDCCH-Config of the dedicated unicast BWP), and one or more SPS-config(s) for MBS (i.e., separate from the SPS-Config of the dedicated unicast BWP).

In some aspects, for RRC_CONNECTED UEs, more than one SPS group-common PDSCH configuration for MBS may be configured per UE subject to UE capability. The total number of SPS configurations supported by a UE currently defined for unicast, in some aspects, may not be increased due to additionally supporting MBS. In some aspects, for RRC_CONNECTED UEs, there is a desire to support HARQ-ACK feedback for a SPS group-common PDSCH for MBS. For activation/deactivation of SPS group-common PDSCH for MBS in RRC_CONNECTED state, in some aspects, it is assumed that at least a group-common PDCCH is supported.

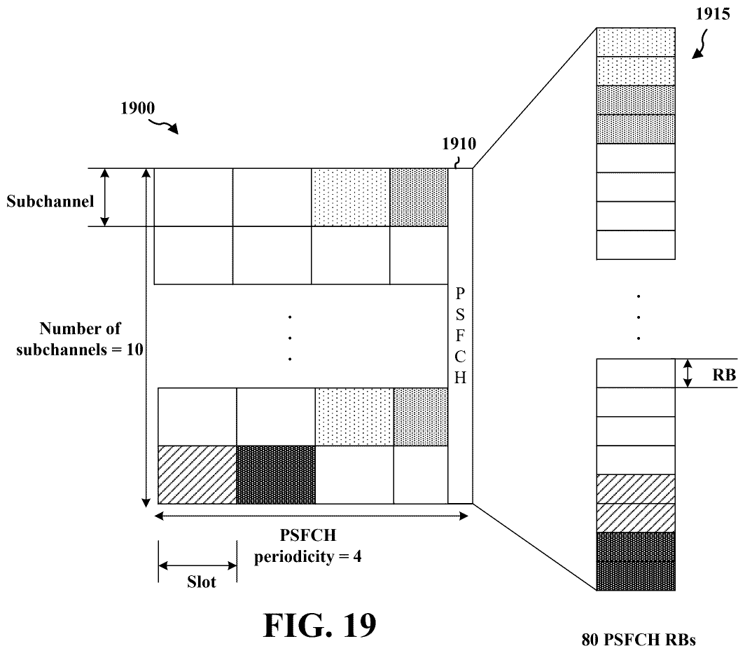

For sidelink communication, e.g., PSSCH, a UE may determine a corresponding PSFCH resource to use to transmit feedback. A parameter may indicate the PFSCH periodicity, e.g., which may be referred to as “periodPSFCHresource.” The parameter may indicate the PFSCH periodicity, in a number of slots, in a resource pool. The periodicity may be set to {0,1,2,4}. If the periodicity is set to 0, PSFCH transmissions from a UE in the resource pool may be disabled. FIG. 19 illustrates an example resource diagram in which the PSFCH periodicity is 4 slots, and shows PFSCH resources 1910 following four slots of resources for PSSCH.

The UE may transmit the PSFCH in a first slot that includes PSFCH resources and is at least a number of slots, provided by a parameter such as “MinTimeGapPSFCH”, of the resource pool after a last slot of the PSSCH reception. A set of M_{PRB,set}^{PSFCH} PRBs in a resource pool for PSFCH transmission may be indicated by a parameter such as “rbSetPSFCH.” A number of N_{subch} sub-channels for the resource pool may be indicated by a parameter such as “numSubchannel.” A number of PSSCH slots associated with a PSFCH slot may be indicated by a parameter such as N_{PSSCH}^{PSFCH} which may be determined based on the periodicity parameter, e.g., periodPSFCHresource.

In some aspects, a total number of resources available for transmitting feedback may be calculated as M_{PRB,set}^{PSFCH}=α·N_{subch}·N_{PSSCH}^{PSFCH}, where a may be related to a number of possible cyclic shifts that may be used to distinguish feedback associated with a same slot and subchannel but with different devices. In some aspects,

$${M}_{subch , slot}^{PSFCH} = \frac{{M}_{PRB , set}^{PSFCH}}{{N}_{subch} . {N}_{PSSCH}^{PSFCH}}$$

represents a number of resources available for feedback for each slot in a sub-channel (or for each sub-channel in a slot). The UE may allocate the [(i+j·N_{PSSCH}^{PSFCH})·M_{subch,slot}^{PSFCH}(i+1+j·N_{PSSCH}^{PSFCH})·M_{subch,slot}^{PSFCH}−1] PRBs from the M_{PRB,set}^{PSFCH} PRBs to slot i and sub-channel j, where 0≤i≤N_{PSSCH}^{PSFCH} and 0≤j≤N_{subch} for feedback. In the example in FIG. 19, the PSFCH periodicity, N_{PSSCH}^{PSFCH}=4, and the number of subchannels for the resource pool is N_{subch}=10, which corresponds to 80 PRBs for the PSFCH resources which provides 80 PRBs for PSFCH. In this example, each sub-channel is associated with 2 PSFCH PRBs, e.g., M_{subch,slot}^{PSFCH}=80/(4*10)=2, and the PSFCH may be sent in one of the 2 PSFCH PRBs. A number of possible cyclic shifts, e.g., a, associated with the PSFCH may increase the total number of resources associated with transmitting feedback for a set of sub-channels and slots associated with a PSFCH resource pool (e.g., by increasing a number of distinct feedback transmissions that may be transmitted via a PRB by a factor of a). In some aspects, there may be a corresponding increase in the number of resources associated with transmitting feedback for each sub-channel in the set of sub-channels associated with the PSFCH resource pool. FIG. 19 illustrates a correspondence between the resources used for the PSSCH shown in resource diagram 1900 and the corresponding PRBs of the PSFCH resources 1915. For groupcast, UEs may send feedback in a single frequency (SFN) manner, e.g., based on the resources in which the groupcast was received.

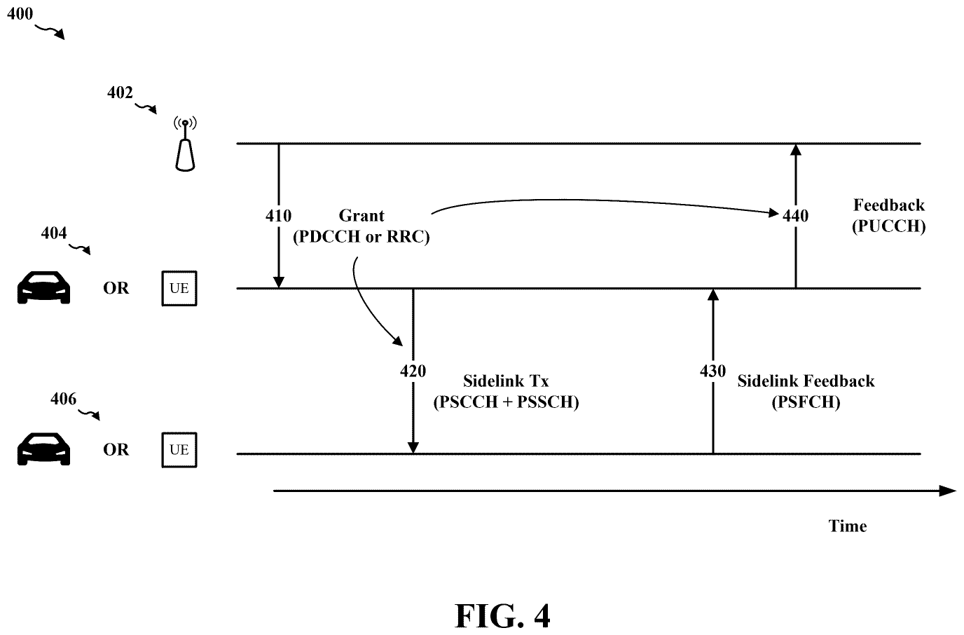

FIG. 4 is a diagram 400 illustrating an example of reporting sidelink feedback to a network entity (e.g., a base station). For example, in some aspects, a network entity 402, may transmit a resource grant 410 via one of PDCCH or RRC signaling to a ‘source’ network node (e.g., vehicle or UE) 404 for a groupcast transmission transmitted by the network node 404 via SL communication. The resource grant 410 may indicate UL resources (e.g., PUCCH resources) for providing feedback to the network entity 402 regarding the groupcast transmission. The network node 404, may in turn transmit a groupcast transmission via sidelink transmission 420. The groupcast transmission may be associated with control information and data transmitted via PSCCH and PSSCH, respectively. The ‘destination’ network node 406 may receive the groupcast transmission based on being associated with a groupcast ID of the groupcast transmission. Based on whether the groupcast transmission was successfully decoded and a feedback configuration (e.g., ACK-only, NACK-only, or an ACK/NACK configuration), the network node 406 may transmit sidelink feedback 430 via PSFCH. For example, if the network node 406 did not accurately receive the PSSCH and/or PSCCH, the network node 406 may transmit a NACK. If the network node 406 did accurately receive the PSSCH and/or PSCCH, the network node 406 may skip sending an ACK. In some aspects, such NACK feedback, without ACK feedback for accurately received PSSCH, may be referred to as NACK only feedback or NACK based feedback. Such NACK based feedback may also be used for feedback to a downlink transmission from a base station, such as a groupcast or multicast PDSCH. In other aspects, the network node 406 may send an ACK if the PSSCH and/or PSCCH was accurately received. Similarly, if a network node receives a PDSCH, the network node may transmit an ACK. Such feedback may be referred to as ACK/NACK feedback, in some aspects. The network node 404 may in turn transmit feedback 440 to the network entity 402 via the PUCCH indicated in the resource grant 410.

In some aspects, the network node 404 associated with a first groupcast feedback configuration (e.g., which may be referred to as groupcast option 1) may report a NACK if (1) it did not transmit PSSCH or (2) it did not receive PSFCH, e.g., due to intra-UE prioritization. The network node 404, in some aspects, associated with a second groupcast feedback configuration (e.g., which may be referred to as groupcast option 2) may report an ACK if it has received an ACK from each of the network nodes (e.g., network node 406) at some point. In some aspects, the network node 404 may transmit an ACK if it does not have data to transmit (e.g., for a configured grant feedback configuration).

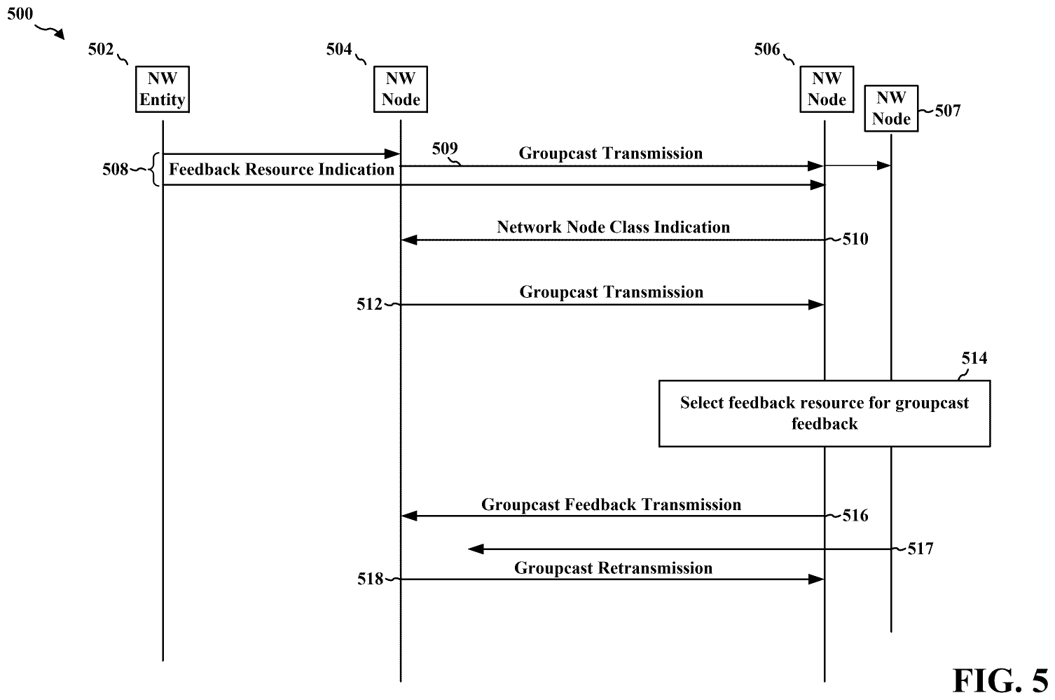

FIG. 5 is a call flow diagram 500 illustrating a groupcast transmission and associated feedback transmission based on a network node class.

The call flow diagram 500 includes a first network node 504 that may be a transmitting network node and a second network node 506 that may be a receiving network node. In some aspects, the first network node 504 may be a first UE, and the second network node 506 may be a second UE that exchanges sidelink communication with the first UE. In other aspects, the first network node 504 may be a base station, or a component of a base station, and the second network node 506 may be a UE that exchanges communication (e.g., downlink and uplink communication) over and access link with the base station. The second network node 506, in some aspects, may transmit, and the first network node 504 may receive, a network node class indication 510 indicating a network node class of the network node. In some aspects, the class indication may indicate whether the second network node 506 is an energy harvesting device (or is in an energy harvesting mode) or is a non-energy harvesting device (or is in a non-energy harvesting mode). In some aspects, there may be multiple classes of energy harvesting devices. The network node class indication 510 may include a network node class ID. The network node class ID may correspond to one of the first subset of resources, the second subset of resources, or an offset values in the plurality of offset values.

The network node 504 may transmit, and the network node 506 may receive, a groupcast transmission 512. The groupcast transmission 512 may be associated with a groupcast ID and a source ID (e.g., a source ID associated with network node 504). The groupcast transmission may be transmitted to and received by multiple network nodes including the network node 506 and network node 507. The groupcast transmission 512 may be successfully decoded at the network node 506 and/or 507 or may not be successfully decoded at the network node 506 and/or 507. Depending on a feedback mode (e.g., an ACK/NACK mode, an ACK-only mode, or a NACK-only mode) and whether the groupcast transmission 512 was successfully decoded, each network node may determine to transmit groupcast feedback. Based on the determination to transmit the groupcast feedback, each network node 506 and 507 may select, at 514, a feedback resource for transmitting the groupcast feedback. The feedback resource for transmitting the feedback resource may be selected, at 514, based on a network node class. The network node 506 and 507 may select between a first subset of feedback resources for non-energy harvesting network nodes and a second subset of feedback resources for energy harvesting network nodes. In some aspects, the first subset of feedback resources may include one or more resource blocks in a different slot or a different sub-channel than the second subset of resources. The first subset of feedback resources, in some aspects, includes one or more resource blocks that are different than the second subset of feedback resources in a same slot or a same sub-channel as the second subset of feedback resources.

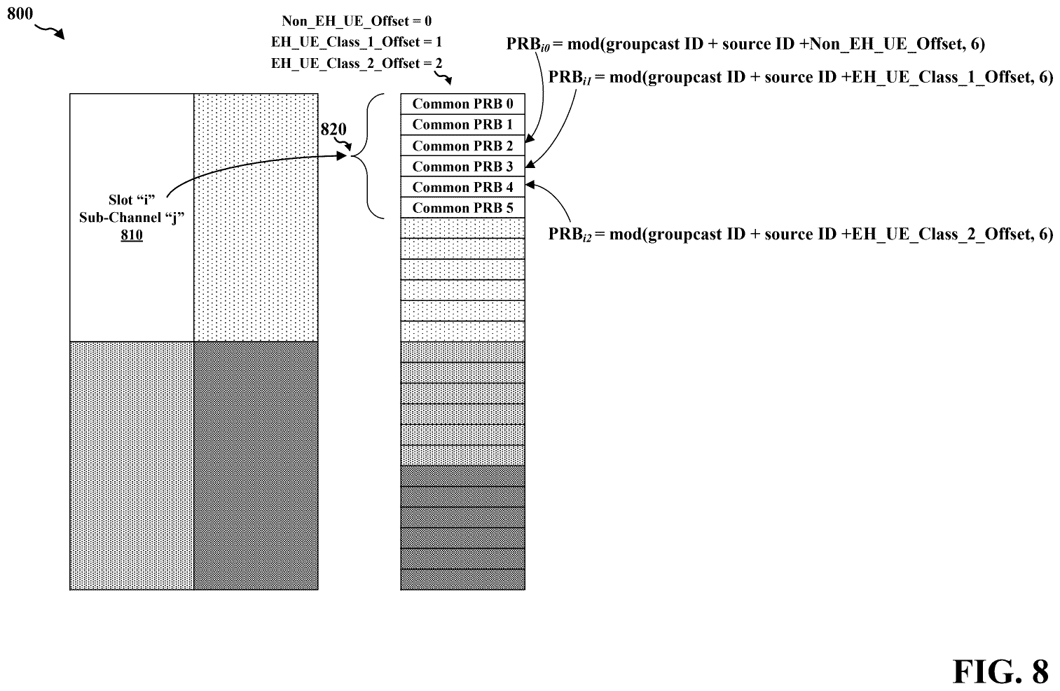

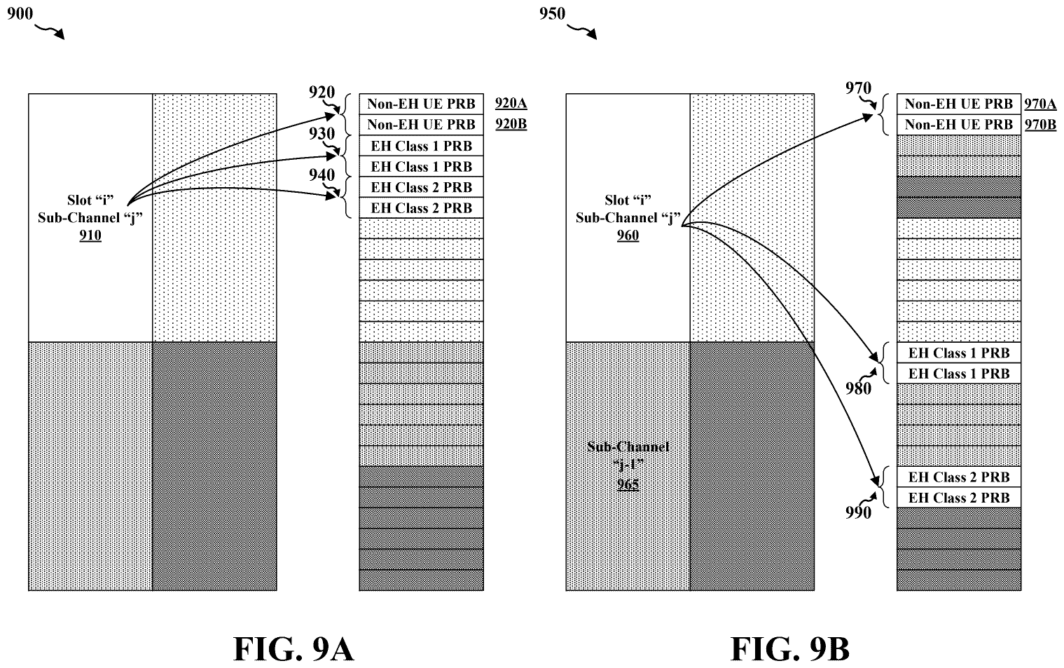

For example, in some aspects, a network node class may be used to identify a feedback resource pool in a set of feedback resource pools associated with a slot and subchannel in which the groupcast transmission 512 was transmitted and a groupcast ID and source ID associated with the groupcast transmission 512 may be used to select a feedback resource within the feedback resource pool as discussed in further detail in relation to FIG. 9A or FIG. 9B. In some aspects, a feedback resource pool may be identified based on a slot and subchannel in which the groupcast transmission 512 was transmitted and a feedback resource within the feedback resource pool may be selected based on the groupcast ID, the source ID, and the network node class (e.g., an offset value associated with the network node class) as discussed in further detail in relation to FIG. 8. For example, a feedback resource within a feedback resource pool including a set of “N” feedback resources may be selected based on a function of the groupcast ID, the source ID, and/or the offset value such as a modulo function (e.g., mod(source ID+groupcast ID, N) or mod(source ID+groupcast ID+offset value, N).

If the groupcast feedback transmission 516 indicates that the network node 506 failed to decode the groupcast transmission (e.g., that a retransmission is desired), the network node 504 may transmit groupcast retransmission 518. The groupcast feedback transmission 517 indicates feedback from the network node 507. The groupcast feedback transmission 516, in some aspects, may indicate that a retransmission is desired by including a NACK bit or by failing to transmit an ACK bit. The type of indication may depend on the feedback configuration, e.g., ACK-only, NACK-only, or ACK/NACK. The network nodes 506 and 507 may be different classes of network nodes. As an example, the network node 506 may be an energy harvesting class, or mode, of network node and may transmit the feedback, at 516, in different resources than the non-energy harvesting class, type, or mode of network node 507.

In some aspects, a network entity 502 may transmit, and a set of network nodes (e.g., network node 504 and network node 506) may receive, a feedback resource indication 508. In some aspects, the network node 504 may provide a groupcast transmission 509 to the network node 506. The feedback resource indication 508 or groupcast transmission 509 may include an indication of a first subset of feedback resources for non-energy harvesting network nodes and a second subset of feedback resources for energy harvesting network nodes. In some aspects, the first subset of feedback resources includes one or more resource blocks in a different slot or a different sub-channel than the second subset of resources. FIG. 9B illustrates an example of resources in different sub-channels. The first subset of feedback resources, in some aspects, includes one or more resource blocks that are different than the second subset of feedback resources in a same slot or a same sub-channel as the second subset of feedback resources. FIG. 9A illustrates an example of different resources within a same sub-channel.

In some aspects, the feedback resource indication 508 or the groupcast transmission 509 may include an indication, for each network node class in a plurality of network node classes including at least one energy harvesting class, a subset of feedback resources associated with the groupcast transmission. The feedback resource indication 508, in some aspects, may include an indication that identifies a correspondence between network node classes (e.g., a network node class identifier (ID)) and offset values in a plurality of offset values that may be used to identify a groupcast feedback resource in addition to a groupcast ID and a source ID. The plurality of network node classes, in some aspects, may include network node classes associated with different energy harvesting characteristics of energy harvesting class network nodes. The different energy harvesting characteristics may relate to one or more of a battery level, an energy harvesting rate, or an energy harvesting mode of operation. In some aspects, the groupcast ID and the source ID may be independent of the network node class of the network node.

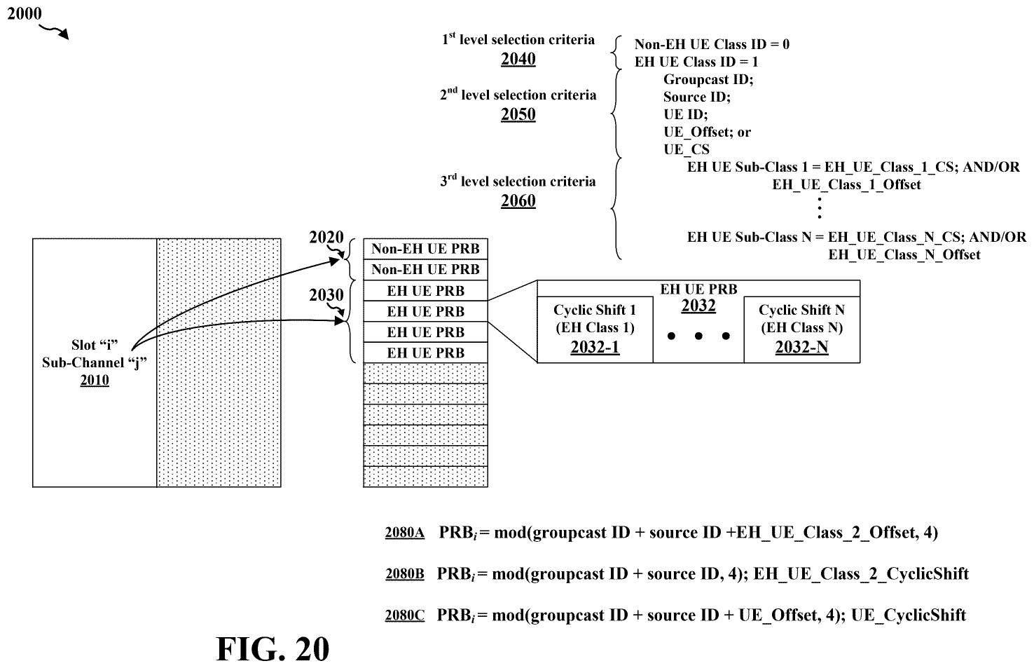

In some aspects, the feedback resource indication 508 or the groupcast transmission 509 may include an indication of a first subset of feedback resources associated with non-EH UEs and a second subset of feedback resources associated with EH UEs and a mechanism/operation for selecting a particular resource within the first and/or second subset of feedback resources for transmitting feedback for a groupcast transmission. FIG. 20 is a diagram 2000 that illustrates first and second subsets of feedback resources corresponding to non-EH UEs and EH UEs respectively. For example, referring to FIG. 20, a first subset of feedback resources 2020 may be assigned for non-EH UEs and a second subset of feedback resources 2030 may be assigned for EH-UE. The selection of a PRB within the first subset of feedback resources and/or the second set of feedback resources is discussed in more detail below in relation to FIG. 20.

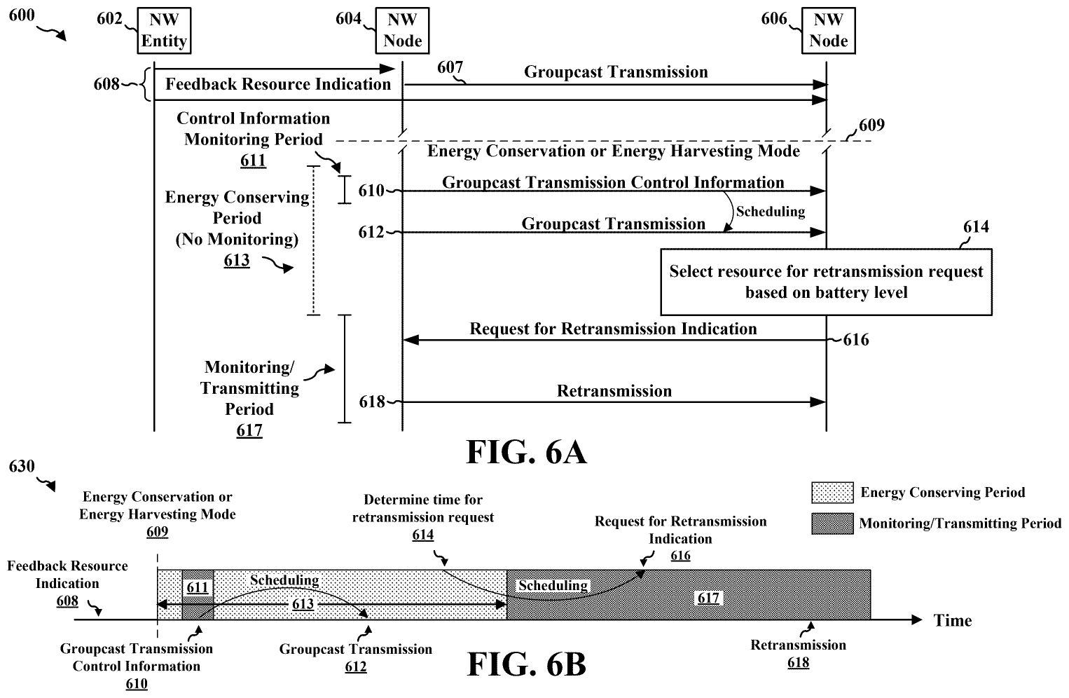

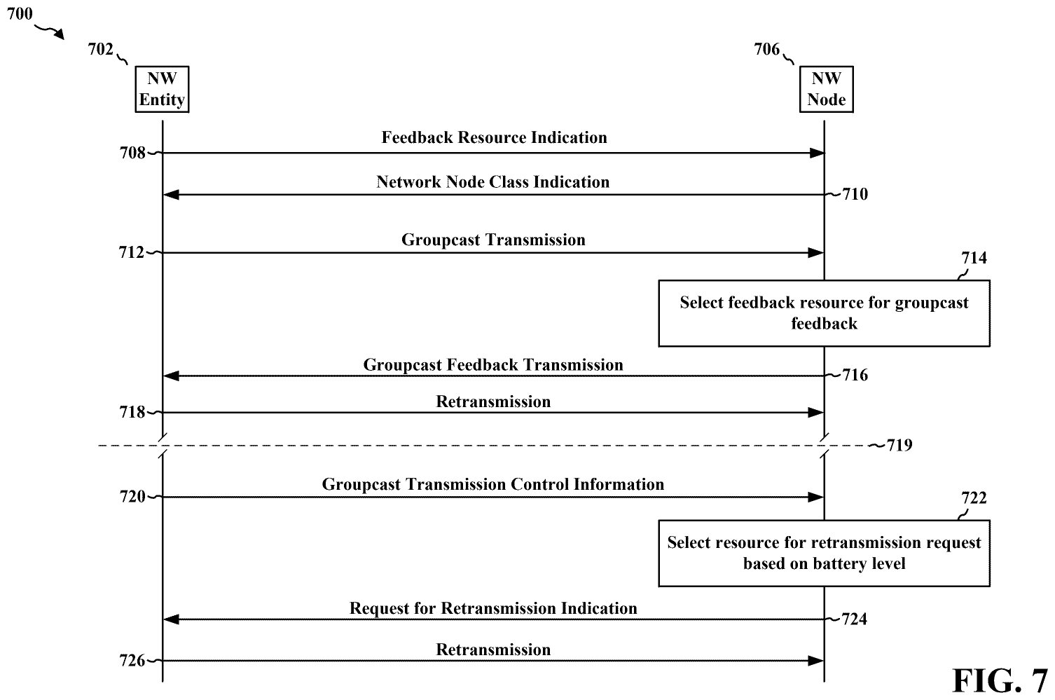

FIG. 6A is a call flow diagram 600 illustrating a groupcast transmission and associated retransmission request indication based on a network node class. In some aspects, the first network node 604 may be a first UE, and the second network node 606 may be a second UE that exchanges sidelink communication with the first UE. In other aspects, the first network node 604 may be a base station, or a component of a base station, and the second network node 606 may be a UE that exchanges communication (e.g., downlink and uplink communication) over and access link with the base station. As described in connection with FIG. 5, a network entity 602 may transmit, and a set of network nodes (e.g., network node 604 and network node 606) may receive, a feedback resource indication 608. In some aspects, the network node 604 may provide a groupcast transmission 607 to one or more other network nodes, including network node 606. The feedback resource indication 608 may include an indication of a first subset of feedback resources for non-energy harvesting network nodes and a second subset of feedback resources for energy harvesting network nodes. While the different subsets of feedback resources described in relation to FIGS. 5 and 7 are in a same time resource (e.g., slot or symbol) but are associated with different frequencies (e.g., sub-channels), diagram 600 illustrates that the different network node classes may also be associated with feedback resources at different times (e.g., slots, or symbols). The different subsets of resources in time may be based on a network node 606 being in, or transitioning to, an energy conservation, or energy harvesting mode, of operation (e.g., associated with an a low-battery-level).

At a time 609, the network node 606 may operate in the energy conservation, or energy harvesting mode, of operation. The energy conservation, or energy harvesting mode, of operation may include an energy conserving period 613 in which the network node 606 does not monitor (e.g., attempt to decode) data transmissions. The network node 606, during the energy conserving period 613, may monitor control information during a control information monitoring period 611. For example, the network node 604 may transmit, and the network node 606 may receive, groupcast transmission control information 610 (e.g., via MAC-CE, DCI, or SCI). The groupcast transmission control information 610 may indicate that a groupcast transmission 612 is scheduled for a time (e.g., a slot or set of symbols) during the energy conserving period 613. The network node 606 may identify that the groupcast transmission 612 scheduled by the groupcast transmission control information 610 may not be decoded based on the groupcast transmission 612 being scheduled during the energy conserving period 613.

The network node 604 may transmit the scheduled groupcast transmission 612 which the network node 606 may not receive and/or decode based on the mode of operation of the network node 606. The network node 606 may select, at 614, a resource for a retransmission request. The selection may be from a set of time resources during a monitoring/transmitting period 617 that are available for transmitting a request for retransmission indication 616. The resource for the retransmission request may be selected based on information included in the feedback resource indication 608 and a current network node class associated with the network node 606. The network node 606 may transmit, and the network node 604 may receive, a request for retransmission indication 616. The network node 604 may monitor or identify the resource selected at 614 based on the feedback resource indication 608 and a network node class (e.g., indicated by a network node class indication 510 or 710 as described in relation to FIGS. 5 and 7). Based on the request for retransmission indication 616, the network node 604 may transmit, and the network node 606 may receive, a groupcast retransmission 618 that is related to the groupcast transmission associated with (or scheduled by) the groupcast transmission control information 610. FIG. 6B is a diagram 630 illustrating the operations of FIG. 6A in a timeline view.

FIGS. 5 and 6A illustrate an architecture or implementation including a first network entity, or a first network node, that configures the groupcast feedback resources and a network node that is a source of at least one groupcast transmission. However, in some aspects, the first network entity may configure the groupcast feedback resources and is a source of the at least one groupcast transmission. In some aspects, the network entity 702 may be a base station, or a component of a base station, and the network node 706 may be a UE that exchanges communication (e.g., downlink and uplink communication) over and access link with the base station. FIG. 7 is a call flow diagram 700 illustrating a groupcast transmission and associated feedback transmission based on a network node class for a first network entity 702 transmitting a groupcast transmission to at least a network node 706. The call flow diagram 700, illustrates a similar set of operations to the operations illustrated in call flow diagram 500 of FIG. 5 and call flow diagram 600 of FIG. 6A, for a groupcast transmission from a network entity 702 to a network node 706. A network entity 702 may transmit, and a network node 706 may receive, a feedback resource indication 708. The feedback resource indication 708 may include an indication of a first subset of feedback resources for non-energy harvesting network nodes and a second subset of feedback resources for energy harvesting network nodes. In some aspects, the first subset of feedback resources includes one or more resource blocks in a different slot or a different sub-channel than the second subset of resources. The first subset of feedback resources, in some aspects, includes one or more resource blocks that are different than the second subset of feedback resources in a same slot or a same sub-channel as the second subset of feedback resources.

In some aspects, the feedback resource indication 708 may include an indication, for each network node class in a plurality of network node classes including at least one energy harvesting class, a subset of feedback resources associated with the groupcast transmission. The feedback resource indication 708, in some aspects, may include an indication that identifies a correspondence between network node classes (e.g., a network node class ID) and offset values in a plurality of offset values that may be used to identify a groupcast feedback resource in addition to a groupcast ID and a source ID. The plurality of network node classes, in some aspects, may include network node classes associated with different energy harvesting characteristics of energy harvesting class network nodes. The different energy harvesting characteristics may relate to one or more of a battery level, an energy harvesting rate, or an energy harvesting mode of operation.

The diagram 700 includes a network entity 702 that may be a transmitting network entity and a network node 706 that may be a receiving network node. The second network node 706, in some aspects, may transmit, and the network entity 702 may receive, a network node class indication 710 indicating a network node class of the network node. The network node class indication 710 may include a network node class ID. The network node class ID may correspond to one of the first subset of resources, the second subset of resources, or an offset values in the plurality of offset values.

The network entity 702 may transmit, and the network node 706 may receive, a groupcast transmission 712. The groupcast transmission 712 may be associated with a groupcast ID and a source ID (e.g., a source ID associated with network entity 702). The groupcast transmission 712 may be successfully decoded at the network node 706 or may not be successfully decoded at the network node 706. Depending on a feedback mode (e.g., an ACK/NACK mode, an ACK-only mode, or a NACK-only mode) and whether the groupcast transmission 712 was successfully decoded, the network node may determine to transmit groupcast feedback. Based on the determination to transmit the groupcast feedback, the network node 706 may select, at 714, a feedback resource for transmitting the groupcast feedback. The feedback resource for transmitting the feedback resource may be selected, at 714, based on a network node class.

For example, in some aspects, a network node class may be used to identify a feedback resource pool in a set of feedback resource pools associated with a slot and subchannel in which the groupcast transmission 712 was transmitted and a groupcast ID and source ID associated with the groupcast transmission 712 may be used to select a feedback resource within the feedback resource pool as discussed in further detail in relation to FIG. 9A or FIG. 9B. In some aspects, a feedback resource pool may be identified based on a slot and subchannel in which the groupcast transmission 712 was transmitted and a feedback resource within the feedback resource pool may be selected based on the groupcast ID, the source ID, and the network node class (e.g., an offset value associated with the network node class) as discussed in further detail in relation to FIG. 8. For example, a feedback resource within a feedback resource pool including a set of “N” feedback resources may be selected based on a function of the groupcast ID, the source ID, and/or the offset value such as a modulo function (e.g., mod(source ID+groupcast ID, N) or mod(source ID+groupcast ID+offset value, N).

If the groupcast feedback transmission 716 indicates that the network node 706 failed to decode the groupcast transmission (e.g., that a retransmission is desired), the network entity 702 may transmit groupcast retransmission 718. The groupcast feedback transmission 716, in some aspects, may indicate that a retransmission is desired by including a NACK bit or by failing to transmit an ACK bit. The type of indication may depend on the feedback configuration, e.g., ACK-only, NACK-only, or ACK/NACK.

The network node class associated with the network node 706 may, or may not, change over time, and, at a later time (e.g., after a time 719), the network node 706 may be operating in an energy harvesting mode of operation or a low-battery-level mode of operation. While operating in the energy harvesting mode of operation or the low-battery-level mode of operation, the network node 706 may receive groupcast transmission control information 720 (e.g., via MAC-CE, DCI, or SCI). The groupcast transmission control information 720 may indicate that a groupcast transmission is scheduled for a time (e.g., a slot or set of symbols) when, due to the energy harvesting mode of operation or the low-battery-level mode of operation, the network node 706 will not decode the groupcast transmission. For example, the network node 706 may operate in a RedCap mode of operation or may schedule periods of inactivity.

Based on not decoding the scheduled groupcast transmission (e.g., based on a low battery level), the network node 706 may select, at 722, a resource for a retransmission request. The resource for the retransmission request may be selected based on information included in the feedback resource indication 708 and a current network node class associated with the network node 706. The network node 706 may transmit, and the network entity 702 may receive, a request for retransmission indication 724. The network entity 702 may monitor or identify the resource selected at 722 based on the feedback resource indication 708 and a network node class (e.g., indicated by network node class indication 710). Based on the request for retransmission indication 724, the network entity 702 may transmit, and the network node 706 may receive, a groupcast retransmission 726 that is related to the groupcast transmission associated with (or scheduled by) the groupcast transmission control information 720.

FIG. 8 is a diagram 800 illustrating a set of slots and sub-channels and a corresponding set of feedback resource pools. For example, a feedback resource pool 820 may be associated with a slot i, in a sub-channel j 810. In diagram 800, the feedback resource pool 820 may be common for the network node classes. The resources in the feedback resource pool 820 may be associated with an index (e.g., a value from 0 to N−1). In order to identify a particular resource (e.g., one of common PRBs 0-5 in feedback resource pool 820), some aspects may utilize a modulo operation based on the number of resources in the feedback resource pool (e.g., mod(groupcast ID+source ID, N). The different network node classes may be associated with different offset values used to identify a resource in a set of feedback resources along with a groupcast ID and a source ID (e.g., mod(groupcast ID+source ID+offset value, N). For example, each network node class may be associated with a different calculation to identify a resource (e.g., PRBᵢ₀, PRBᵢ₁, or PRBᵢ₂).

The different offset values may allow network nodes operating in different modes (e.g., different modes of operation associated with different feedback configurations such as ACK-only, NACK-only, or ACK/NACK feedback) to be differentiated. Based on the example of using the modulo operation as described above, for a number of different modes of operation (and offset values) that are equal to, or less than, the number of resources in the feedback resource pool 820, using the different offset values ensures that different resources are selected for different modes of operation. For example, in diagram 800 a first resource (e.g., common PRB 2) may be selected for a “non-EH UE” network node class based on a groupcast ID, a source ID, and the offset value (e.g., Non_EH_UE_Offset=0), while a second resource (e.g., common PRB 3) and a third resource (e.g., common PRB 4) may be selected for a first “EH UE” network node class and a second “EH UE” network node class, respectively, based on the offset values associated with the first “EH UE” network node class (EH_UE_Class 1_Offset=1) and the offset values associated with the second “EH UE” network node class (EH_UE_Class 2_Offset=2). In some aspects, a destination ID associated with the UE that receives the particular groupcast transmission may also be used to select the particular feedback resource for either non-EH network nodes (e.g., UEs), or EH network nodes (e.g., UEs).

The differentiation may be beneficial to distinguish between a lack of feedback in a NACK-only feedback configuration based on a failure to decode a groupcast transmission and a lack of feedback based on a lack of power for transmitting groupcast feedback (or a lack of power for decoding a groupcast transmission). Additionally, different feedback configurations may be associated with different network node classes in some aspects that better reflect the needs of the different modes of operation. For example, a first mode of operation associated with a non-EH mode of operation (e.g., for a high battery level) may be configured to use a NACK-only feedback while an EH/energy conserving mode of operation (e.g., for a low, or ultra-low, battery level) may be configured to use ACK-only feedback or ACK/NACK feedback. The ACK-only or ACK/NACK feedback may be used because the lack of feedback in such EH and/or energy-conserving modes of operation may be based on the network node not having sufficient power to monitor and/or decode a groupcast transmission and may not be based on successfully decoding the groupcast transmission.

FIG. 9A is a diagram 900 illustrating a first configuration for disjoint feedback resource pools for different network node classes. Diagram 900 illustrates that a resource pool that is in a same subchannel “j” as a slot “i” may be divided into first, second, and third subsets of feedback resources (e.g., feedback resource subset 920, resource subset 930, and resource subset 940). Each of the resource subsets may include multiple feedback resources. For example, feedback resource subset 920 may include a first feedback resource 920A and a second resource 920B. For a particular groupcast transmission via the slot “i” in subchannel “j” 910, a network node class may be used to identify and/or select one of feedback resource subset 920, 930, or 940, while a groupcast ID and source ID may be used to select a resource within the identified and/or selected resource subset (e.g., based on a modulo operation on the sum of the groupcast ID and source ID divided by the number of feedback resources in the selected resource subset).

FIG. 9B is a diagram 950 illustrating a first configuration for disjoint feedback resource pools for different network node classes. Diagram 950 illustrates that a resource pool for a slot “i” in a subchannel “j” 960 and may be divided into first, second, and third subsets of feedback resources (e.g., feedback resource subset 920, resource subset 930, and resource subset 940) in a plurality of sub-channels (e.g., sub-channel “j” and sub-channel “j−1” 965). Each of the resource subsets may include multiple feedback resources. For example, resource subset 970 may include a first feedback resource 970A and a second resource 970B. For a particular groupcast transmission via the slot “i” in subchannel “j” 960, a network node class may be used to identify and/or select one of resource subset 970, 980, or 990, while a groupcast ID and source ID may be used to select a resource within the identified and/or selected resource subset (e.g., based on a modulo operation on the sum of the groupcast ID and source ID divided by the number of feedback resources in the selected resource subset). In some aspects, by allocating feedback resource pools for network node classes associated with EH operations and/or low-battery-level modes of operation in a sub-channel different from the sub-channel in which the groupcast transmission was transmitted, the configuration ensures that legacy network nodes that select nodes in a same sub-channel as a transmitted groupcast transmission will not select feedback resources that are the same as the feedback resources selected be an EH network node.

FIG. 20 is a diagram 2000 that illustrates first and second subsets of feedback resources corresponding to non-EH UEs and EH UEs respectively. For example, referring to FIG. 20, a first subset of feedback resources 2020 may be assigned for non-EH UEs and a second subset of feedback resources 2030 may be assigned for EH-UE. To select a feedback resource for a particular groupcast transmission (e.g., groupcast transmission 509, 607, or 712), a UE may select the first subset of feedback resources 2020 if the UE is a non-EH UE or the second subset of feedback resources 2030 if the UE is an EH UE. After selecting a subset of feedback resources, the UE may select a particular feedback resource in the selected subset of feedback resources. The particular resource may be selected as depicted in FIG. 8 based on a groupcast ID and a source ID associated with the particular groupcast transmission.

In some aspects, for EH UEs that select the second subset of feedback resources 2030, selecting the particular feedback resource may include selecting a resource based on a cyclic shift associated with an EH UE class of the UE, an offset associated with the EH UE class of the UE, and/or other characteristics of the source or destination UE or the groupcast transmission as discussed above in relation to FIG. 8. For example, a groupcast ID and source ID may be used to select a PRB from a subset of EH UE feedback resources according to a modulo operation as described in relation to FIG. 8 and an EH UE class may be used to determine a cyclic shift (or an offset value as in FIG. 8) from a set of 2 or more cyclic shifts. For example, if EH UE PRB 2032 is selected from the second subset of feedback resources 2030 based on a groupcast ID and source ID associated with a groupcast transmission, the network node (or UE) may select from resources associated with different cyclic shifts, e.g., cyclic shift 2032-1 to cyclic shift 2032-N. While the different cyclic shifts, in some aspects, may not correspond to different physical resources, they may be referred to as different feedback resources based on being able distinguish between feedback transmission associated with different cyclic shifts transmitted over a same physical (e.g., time and frequency) resource.

In general, FIG. 20 illustrates that different criteria may be used to select resources at different levels of granularity. For example, a set of first level selection criteria 2040 may be used to select between first and second subsets of feedback resources 2020 and 2030. In some aspects, one or more of a set of second level selection criteria 2050, e.g., a groupcast ID, a source ID, a UE ID, a UE-specific Offset, and/or a UE-specific cyclic shift may be used to select a particular feedback resource (and/or a cyclic shift) within the selected subset of resources. In some aspects not including a UE-specific cyclic shift, a cyclic shift (or RB offset) may be selected based on a cyclic shift (or offset value) associated with the EH UE class ID in the set of third level selection criteria 2060. For example, one of operation 2080A, operation 2080B, or operation 2080C may be used to identify a PRB and a cyclic shift for transmitting feedback for a groupcast ID, where the operation 2080B using one or more of the UE-specific offset value and cyclic shift may be used in a multi-stage/level selection or a direct selection as described in relation to FIG. 8.

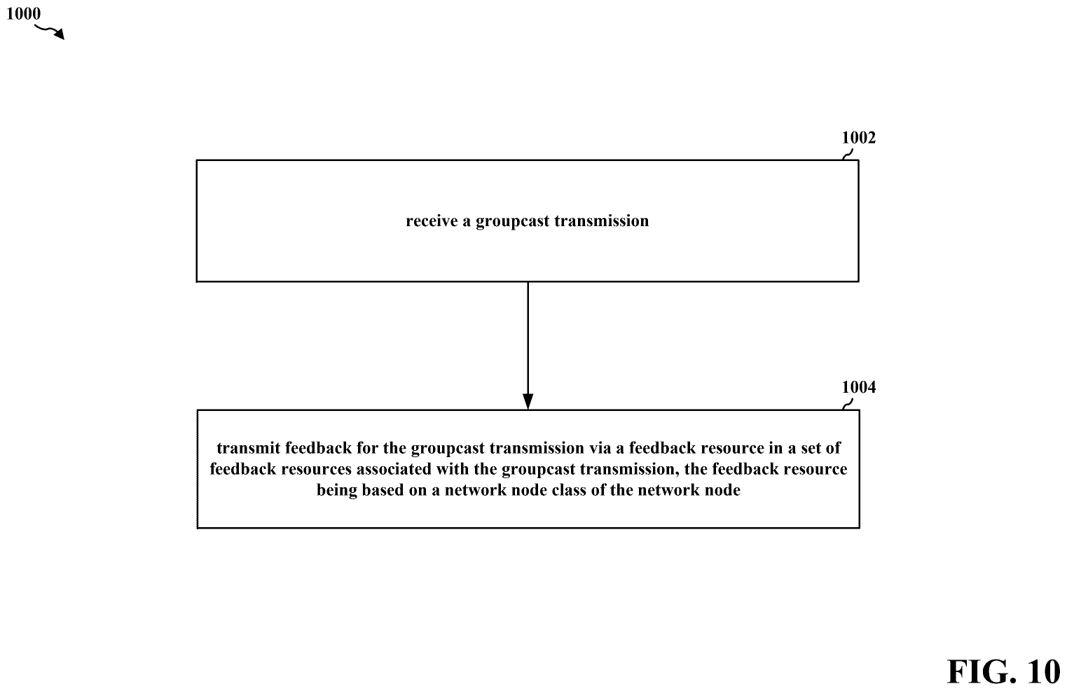

FIG. 10 is a flowchart 1000 of a method of wireless communication. The method may be performed by a network node (e.g., the UE 104; the network node 506, 706, or 606; the apparatus 1604). At 1002, the network node may receive a groupcast transmission. For example, 1002 may be performed by groupcast feedback resource selection component 198, the cellular baseband processor 1624, the transceiver 1622, and/or antenna(s) 1680. The groupcast transmission received at 1002 may, in some aspects, be associated with a groupcast ID and a source ID corresponding to a network node or network entity from which the groupcast transmission is received. For example, referring to FIGS. 5, 7, 8, 9A, 9B, and 20, a network node 506 or 706 may receive a groupcast transmission 512 or 712 (e.g., via a slot i, in the sub-channel j 810, 910, 960, or 2010).

In some aspects, the network node may receive an indication, for each network node class in a plurality of network node classes including at least one energy harvesting class, a subset of feedback resources associated with the groupcast transmission. The indication may be received by groupcast feedback resource selection component 198, the cellular baseband processor 1624, the transceiver 1622, and/or antenna(s) 1680. The feedback resource indication, in some aspects, may include an indication of a first subset of feedback resources for non-energy harvesting network nodes and a second subset of feedback resources for energy harvesting network nodes. In some aspects, the first subset of feedback resources includes one or more resource blocks in a different slot or a different sub-channel than the second subset of resources. The first subset of feedback resources, in some aspects, includes one or more resource blocks that are different than the second subset of feedback resources in a same slot or a same sub-channel as the second subset of feedback resources. For example, referring to FIGS. 5, 7, 9A, 9B, and 20, the network node 506 or 706 may receive feedback resource indication 508 or 708 that may indicate the feedback resource subsets 920, 930, 940, 970, 980, 990, 2020, and 2030.

In some aspects, the feedback resource indication may include an indication, for each network node class in a plurality of network node classes including at least one energy harvesting class, a subset of feedback resources associated with the groupcast transmission. The feedback resource indication, in some aspects, may include an indication that identifies a correspondence between network node classes (e.g., a network node class ID) and offset values in a plurality of offset values that may be used to identify a groupcast feedback resource in addition to a groupcast ID and a source ID. The plurality of network node classes, in some aspects, may include network node classes associated with different energy harvesting characteristics of energy harvesting class network nodes. The different energy harvesting characteristics may relate to one or more of a battery level, an energy harvesting rate, or an energy harvesting mode of operation. For example, referring to FIGS. 5, 7, and 8, the network node 506 or 706 may receive feedback resource indication 508 or 708 that may indicate the offset values Non_EH_UE_Offset=0, EH_UE_Class 1_Offset=1, and EH_UE_Class 2_Offset=2 for selecting resources in the feedback resource pool 820 that may also be indicated in the feedback resource indication 508 or 708.

The network node, in some aspects, may transmit an indication of a network node class of the network node. The indication of the network node class may be transmitted before or after receiving the groupcast transmission at 1002. The indication of the network node class of the network node may be transmitted to a network node or network entity that is the source of the groupcast transmission received at 1002. The transmission of the network node class indication may be performed by groupcast feedback resource selection component 198, the cellular baseband processor 1624, the transceiver 1622, and/or antenna(s) 1680. For example, referring to FIGS. 5 and 7, the network node 506 or 706 may transmit the network node class indication 510 or 710 indicating a network node class of the network node.

After receiving the groupcast transmission at 1002, the network node may, in some aspects, select, based on the network node class of the network node, a feedback resource from a subset of feedback resources associated with the network node class of the network node. Selecting the feedback resources may be performed by groupcast feedback resource selection component 198, the application processor 1606, or the cellular baseband processor 1624. As discussed above, the subset of feedback resources may be in a subset of feedback resources that is common to all the network node classes such that selecting the feedback resource includes (1) identifying the common subset of feedback resources and (2) selecting a resource in the identified common subset of feedback resources as described above (e.g., based on a modulo operation based on the groupcast ID, the source ID, and an offset vale associated with the network node class over the resources of the common subset of feedback resources). In some aspects, the subset of feedback resources associated with the network node class of the network node may be a subset of feedback resources that may be disjoint from subsets of resources that are associated with other network node classes such that selecting the feedback resource may include (1) identifying the subset of resources associated with the network node class of the network node and (2) selecting a feedback resource within the subset of feedback resources associated with the network node class of the network node as described above (e.g., based on a modulo operation based on the groupcast ID and the source ID over the resources of the subset of feedback resources). For example, referring to FIGS. 5 and 7, the network node 506 or 706 may select, at 514 or 714, the feedback resource for groupcast feedback related to groupcast transmission 512 or 712.

At 1004, the network node may transmit feedback for the groupcast transmission received at 1002 via a feedback resource in a set of feedback resources associated with the groupcast transmission. In some aspects, as described above, the feedback resource may be based on a network node class of the network node. For example, 1004 may be performed by groupcast feedback resource selection component 198, the cellular baseband processor 1624, the transceiver 1622, and/or antenna(s) 1680. The feedback for the groupcast transmission may be one of an ACK or a NACK depending on the feedback mode/configuration, e.g., ACK-only, NACK-only, or ACK/NACK, which may in turn depend on the network node class of the network node. If the groupcast feedback transmission transmitted at 1004 indicates that the network node failed to decode the groupcast transmission (e.g., that a retransmission is desired), the source of the groupcast transmission may retransmit the groupcast transmission. The groupcast feedback transmission, in some aspects, may indicate that a retransmission is desired by including a NACK bit. In some aspects, the network node may skip the transmission at 1004 to indicate, by failing to transmit an ACK bit, that a retransmission is desired. For a network node class that is associated with an energy harvesting mode of operation or a low battery level/energy conserving mode of operation, an ACK-only or ACK/NACK feedback configuration may be used. The ACK-only or ACK/NACK feedback configuration may be used to avoid misinterpreting a failure to transmit feedback due to an energy conservation operation (e.g., that prevents and/or preempts feedback transmission or decoding operations) as a failure to transmit feedback due to a successful decoding of the groupcast transmission. For example, referring to FIGS. 5, 7, 8, 9A, 9B, and 20, the network node 506 or 706 may transmit groupcast feedback transmission 516 or 716 via a feedback resource selected from one of the feedback resource pool 820 or the feedback resource subsets 920, 930, 940, 970, 980, 990, 2020, or 2030.

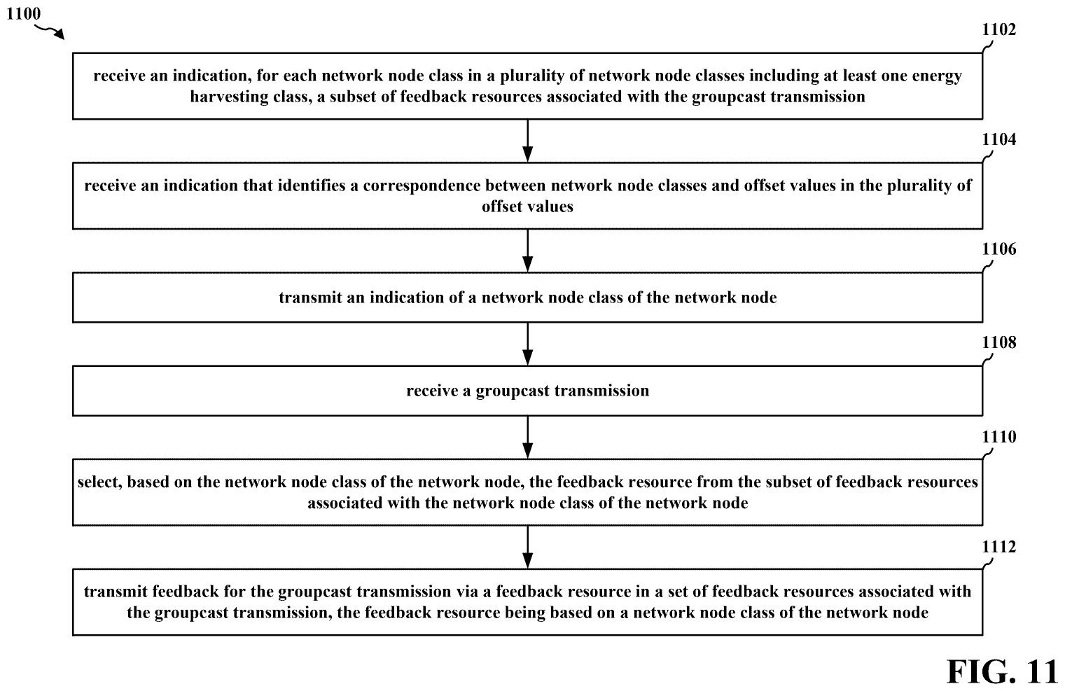

FIG. 11 is a flowchart 1100 of a method of wireless communication. The method may be performed by a network node (e.g., the UE 104; the network node 506, 706, or 606; the apparatus 1604). At 1102, In some aspects, the network node may receive an indication, for each network node class in a plurality of network node classes including at least one energy harvesting class, a subset of feedback resources associated with the groupcast transmission. For example, 1102 may be performed by groupcast feedback resource selection component 198, the cellular baseband processor 1624, the transceiver 1622, and/or antenna(s) 1680. The feedback resource indication, in some aspects, may include an indication of a first subset of feedback resources for non-energy harvesting network nodes and a second subset of feedback resources for energy harvesting network nodes. In some aspects, the first subset of feedback resources includes one or more resource blocks in a different slot or a different sub-channel than the second subset of resources. The first subset of feedback resources, in some aspects, includes one or more resource blocks that are different than the second subset of feedback resources in a same slot or a same sub-channel as the second subset of feedback resources. For example, referring to FIGS. 5, 7, 9A, 9B, and 20, the network node 506 or 706 may receive feedback resource indication 508 or 708 that may indicate the feedback resource subsets 920, 930, 940, 970, 980, 990, 2020, and 2030.

At 1104, the network node may receive an indication that identifies a correspondence between network node classes (e.g., a network node class ID) and offset values in a plurality of offset values. The offset values, in some aspects, may be used to identify a groupcast feedback resource in addition to a groupcast ID and a source ID. For example, 1104 may be performed by groupcast feedback resource selection component 198, the cellular baseband processor 1624, the transceiver 1622, and/or antenna(s) 1680. In some aspects, receiving the indication at 1104 may be included in the feedback resource indication received at 1102. The feedback resource indication, in some aspects, may include an indication that identifies a correspondence between network node classes (e.g., a network node class ID) and offset values in a plurality of offset values that may be used to identify a groupcast feedback resource in addition to a groupcast ID and a source ID. The plurality of network node classes, in some aspects, may include network node classes associated with different energy harvesting characteristics of energy harvesting class network nodes. The different energy harvesting characteristics may relate to one or more of a battery level, an energy harvesting rate, or an energy harvesting mode of operation. For example, referring to FIGS. 5, 7, and 8, the network node 506 or 706 may receive feedback resource indication 508 or 708 that may indicate the offset values Non_EH_UE_Offset=0, EH_UE_Class 1_Offset=1, and EH_UE_Class 2_Offset=2 for selecting resources in the feedback resource pool 820 that may also be indicated in the feedback resource indication 508 or 708.

At 1106, the network node, in some aspects, may transmit an indication of a network node class of the network node. For example, 1106 may be performed by groupcast feedback resource selection component 198, the cellular baseband processor 1624, the transceiver 1622, and/or antenna(s) 1680. The indication of the network node class may be transmitted at 1106 before or after receiving the groupcast transmission at 1108. The indication of the network node class of the network node may be transmitted to a network node or network entity that is the source of the groupcast transmission received at 1108. For example, referring to FIGS. 5 and 7, the network node 506 or 706 may transmit the network node class indication 510 or 710 indicating a network node class of the network node.

At 1108, the network node may receive a groupcast transmission. For example, 1108 may be performed by groupcast feedback resource selection component 198, the cellular baseband processor 1624, the transceiver 1622 and/or antenna(s) 1680. The groupcast transmission received at 1108 may, in some aspects, be associated with a groupcast ID and a source ID corresponding to a network node or network entity from which the groupcast transmission is received. For example, referring to FIGS. 5, 7, 8, 9A, 9B, and 20, a network node 506 or 706 may receive a groupcast transmission 512 or 712 (e.g., via a slot i, in the sub-channel j 810, 910, 960, or 2010).

At 1110, the network node may, in some aspects, select, based on the network node class of the network node, a feedback resource for transmitting groupcast feedback in response to the groupcast transmission received at 1108 from a subset of feedback resources associated with the network node class of the network node. For example, 1110 may be performed by groupcast feedback resource selection component 198, the application processor 1606, or the cellular baseband processor 1624. As discussed above, the subset of feedback resources may be in a subset of feedback resources that is common to all the network node classes such that selecting the feedback resource includes (1) identifying the common subset of feedback resources and (2) selecting a resource in the identified common subset of feedback resources as described above (e.g., based on a modulo operation based on the groupcast ID, the source ID, and an offset vale associated with the network node class over the resources of the common subset of feedback resources). In some aspects, the subset of feedback resources associated with the network node class of the network node may be a subset of feedback resources that may be disjoint from subsets of resources that are associated with other network node classes such that selecting the feedback resource may include (1) identifying the subset of resources associated with the network node class of the network node and (2) selecting a feedback resource within the subset of feedback resources associated with the network node class of the network node as described above (e.g., based on a modulo operation based on the groupcast ID and the source ID over the resources of the subset of feedback resources). For example, referring to FIGS. 5 and 7, the network node 506 or 706 may select, at 514 or 714, the feedback resource for groupcast feedback related to groupcast transmission 512 or 712.

At 1112, the network node may transmit feedback for the groupcast transmission received at 1108 via a feedback resource in a set of feedback resources associated with the groupcast transmission. In some aspects, as described above, the feedback resource may be based on a network node class of the network node. For example, 1112 may be performed by groupcast feedback resource selection component 198, the cellular baseband processor 1624, the transceiver 1622 and/or antenna(s) 1680. The feedback for the groupcast transmission may be one of an ACK or a NACK depending on the feedback mode/configuration, e.g., ACK-only, NACK-only, or ACK/NACK, which may in turn depend on the network node class of the network node. If the groupcast feedback transmission transmitted at 1112 indicates that the network node failed to decode the groupcast transmission (e.g., that a retransmission is desired), the source of the groupcast transmission may retransmit the groupcast transmission. The groupcast feedback transmission, in some aspects, may indicate that a retransmission is desired by including a NACK bit. In some aspects, the network node may skip the transmission at 1112 to indicate, by failing to transmit an ACK bit, that a retransmission is desired. For a network node class that is associated with an energy harvesting mode of operation or a low battery level/energy conserving mode of operation, an ACK-only or ACK/NACK feedback configuration may be used. The ACK-only or ACK/NACK feedback configuration may be used to avoid misinterpreting a failure to transmit feedback due to an energy conservation operation (e.g., that prevents and/or preempts feedback transmission or decoding operations) as a failure to transmit feedback due to a successful decoding of the groupcast transmission. For example, referring to FIGS. 5, 7, 8, 9A, 9B, and 20, the network node 506 or 706 may transmit groupcast feedback transmission 516 or 716 via a feedback resource selected from one of the feedback resource pool 820 or the feedback resource subsets 920, 930, 940, 970, 980, 990, 2020, and 2030.

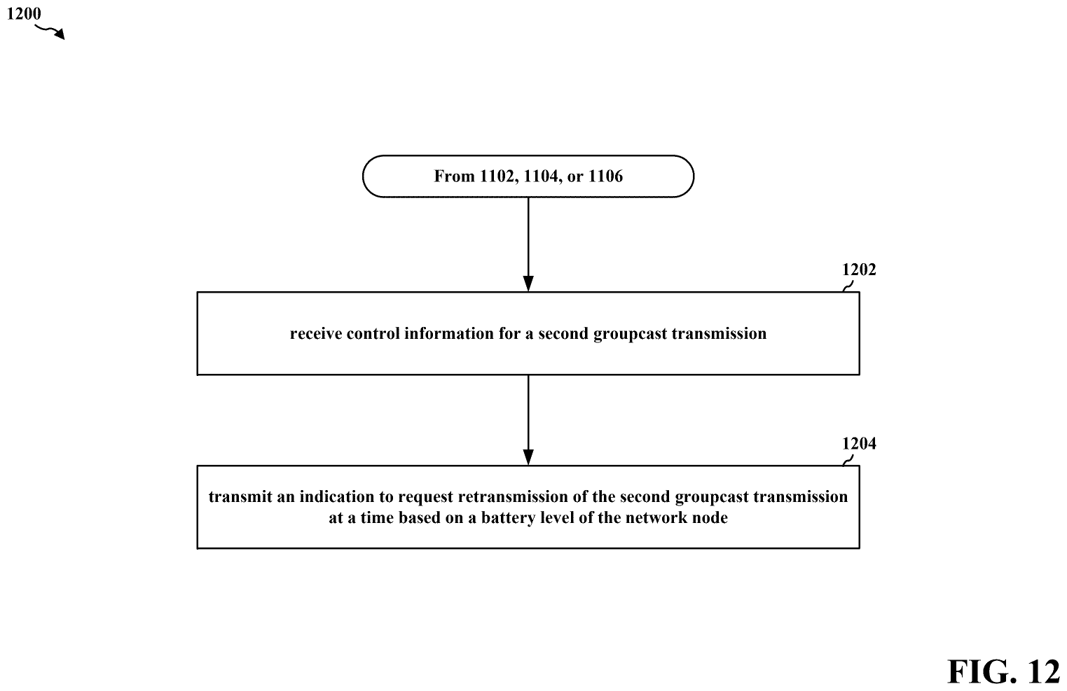

FIG. 12 is a flowchart 1200 of a method of wireless communication. The method may be performed by a network node (e.g., the UE 104; the network node 506, 706, or 606; the apparatus 1604). The method may be performed after any of the operations 1102, 1104, or 1106 of FIG. 11 and may be independent of the groupcast transmission received by the network node at 1002 and the feedback transmitted for the groupcast transmission at 1004 of FIG. 10. At 1202, the network node may receive control information for a groupcast transmission. For example, 1202 may be performed by groupcast feedback resource selection component 198, the cellular baseband processor 1624, the transceiver 1622, and/or antenna(s) 1680. The network node may receive the control information for the groupcast transmission via MAC-CE, DCI, or SCI. The network node may be operating in an energy harvesting mode of operation and/or an energy conservation mode of operation that prevents and/or preempts feedback transmission or decoding operations based on, e.g., a battery level of the network node or an energy harvesting operation. The control information for the groupcast transmission received at 1202 may indicate that a groupcast transmission is scheduled for a time (e.g., a slot or set of symbols) when, due to the energy harvesting mode of operation or the energy conservation (e.g., a low battery level) mode of operation, the network node may not decode the groupcast transmission. For example, the network node may operate in a reduced capacity (RedCap) mode of operation or may schedule periods of inactivity. For example, referring to FIG. 6A, the network node 606 may receive groupcast transmission control information 610 indicating that a groupcast transmission 612 is scheduled for a time (e.g., a slot or set of symbols) during the energy conserving period 613.

Based on not decoding the scheduled groupcast transmission (e.g., based on a low battery level), the network node may select a resource for a retransmission request. The selection may be from a set of time resources during a monitoring/transmitting period that are available for transmitting a request for retransmission indication. The resource for the retransmission request may be selected based on information included in a feedback resource indication (e.g., an indication received at 1102) and a current network node class associated with the network node. For example, referring to FIG. 6A, the network node 606 may select, at 614, a resource for a retransmission request, e.g., from a set of time resources during a monitoring/transmitting period 617 that are available for transmitting a request for retransmission indication 616. The resource for the retransmission request, in some aspects, may be selected based on information included in the feedback resource indication 608 and a current network node class associated with the network node 606.

At 1204, the network node may transmit an indication to request retransmission of the (second) groupcast transmission at a time based on a battery level (or network node class) of the network node. For example, 1202 may be performed by groupcast feedback resource selection component 198, the cellular baseband processor 1624, the transceiver 1622, and/or antenna(s) 1680. The source of the control information for the groupcast transmission may monitor or identify the resource selected at 1204 based on the feedback resource indication (as described in relation to 1102 of FIG. 11) and a network node class (e.g., indicated by a network node class indication as described in relation to 1106 of FIG. 11). Based on the indication to request retransmission of the (second) groupcast transmission transmitted at 1204, the source of the control information for the groupcast transmission may transmit, and the network node may receive, a groupcast retransmission that is related to the groupcast transmission associated with (or scheduled by) the control information for the groupcast transmission. For example, referring to FIG. 6A, the network node 606 may transmit, via the resource selected at 614, the request for retransmission indication 616 based on the groupcast transmission control information 610 indicating that the groupcast transmission 612 is scheduled for a time (e.g., a slot or set of symbols) during the energy conserving period 613.

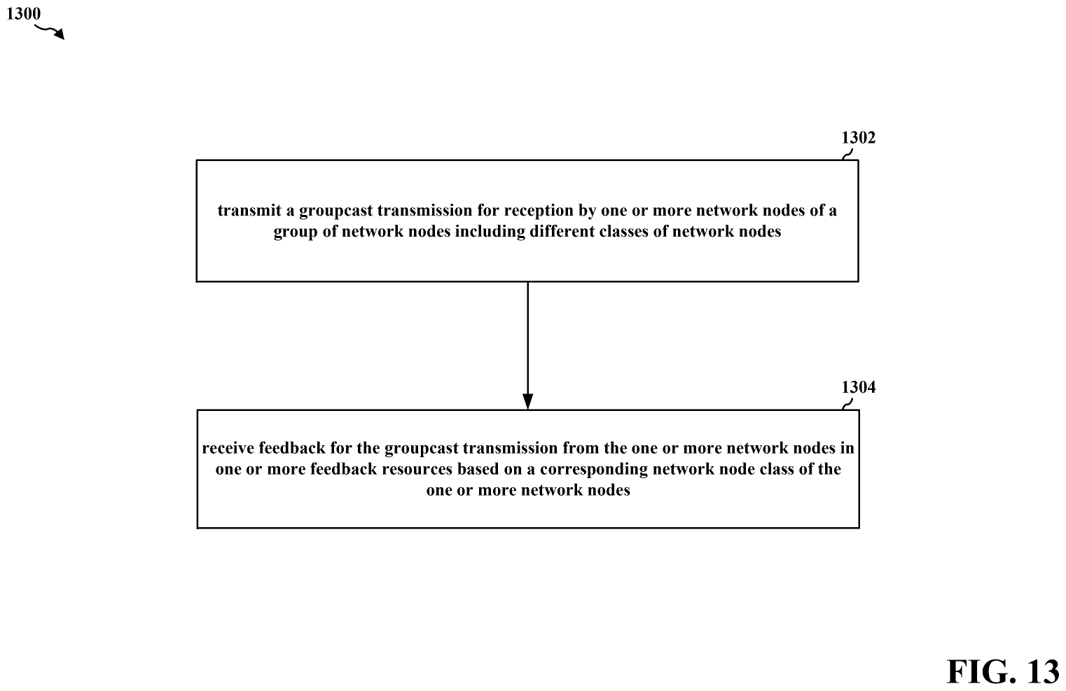

FIG. 13 is a flowchart 1300 of a method of wireless communication. The method may be performed by a network entity or network node (e.g., the UE 104; the BS 102; the network entity, 602, or 702; the network node 504 or 604; the apparatus 1704). At 1302, the network entity or network node may transmit a groupcast transmission for reception by one or more network nodes of a group of network nodes including different classes of network nodes. For example, 1302 may be performed by groupcast feedback resource indication component 199, the cellular baseband processor 1724, the transceiver 1722, and/or antenna(s) 1780. The groupcast transmission transmitted at 1302 may, in some aspects, be associated with a groupcast ID and a source ID corresponding to the network entity node or the network entity transmitting the groupcast transmission at 1302. For example, referring to FIGS. 5, 7, 8, 9A, 9B, and 20, a network node 504 or a network entity 702 may transmit a groupcast transmission 512 or 712 (e.g., via a slot i, in the sub-channel j 810, 910, 960, or 2010).

In some aspects, the network node may transmit (or receive) an indication, for each network node class in a plurality of network node classes, of a set of feedback resources associated with the groupcast transmission. The indication may be transmitted by groupcast feedback resource indication component 199, the cellular baseband processor 1724, the transceiver 1722, and/or antenna(s) 1780. The indication, in some aspects, may include an indication of a first subset of feedback resources for non-energy harvesting network nodes and a second subset of feedback resources for energy harvesting network nodes. In some aspects, the first subset of feedback resources includes one or more resource blocks in a different slot or a different sub-channel than the second subset of resources. The first subset of feedback resources, in some aspects, includes one or more resource blocks that are different than the second subset of feedback resources in a same slot or a same sub-channel as the second subset of feedback resources. For example, referring to FIGS. 5, 7, 9A, 9B, and 20, the network entity 502 or 702 may transmit feedback resource indication 508 or 708 that may indicate the feedback resource subsets 920, 930, 940, 970, 980, 990, 2020, and 2030.

In some aspects, the feedback resource indication may include an indication, for each network node class in a plurality of network node classes including at least one energy harvesting class, a subset of feedback resources associated with the groupcast transmission. The feedback resource indication, in some aspects, may include an indication that identifies a correspondence between network node classes (e.g., a network node class ID) and offset values in a plurality of offset values that may be used to identify a groupcast feedback resource in addition to a groupcast ID and a source ID. The plurality of network node classes, in some aspects, may include network node classes associated with different energy harvesting characteristics of energy harvesting class network nodes. The different energy harvesting characteristics may relate to one or more of a battery level, an energy harvesting rate, or an energy harvesting mode of operation. For example, referring to FIGS. 5, 7, and 8, the network entity 502 or 702 may transmit feedback resource indication 508 or 708 that may indicate the offset values Non_EH_UE_Offset=0, EH_UE_Class 1_Offset=1, and EH_UE_Class 2_Offset=2 for selecting resources in the feedback resource pool 820 that may also be indicated in the feedback resource indication 508 or 708.

The network entity or network node, in some aspects, may receive, for each of the one or more (groupcast destination) network nodes, an indication of a network node class from a plurality of network node classes. The indication of the network node class for a particular (groupcast destination) network node may be transmitted before or after transmitting the groupcast transmission at 1302. The reception of the network node class indication for each of the one or more (groupcast destination) network nodes may be performed by groupcast feedback resource indication component 199, the cellular baseband processor 1724, the transceiver 1722, and/or antenna(s) 1780. For example, referring to FIGS. 5 and 7, the network node 504, or the network entity 702 may receive from network node 506 or 706 the network node class indication 510 or 710 indicating a network node class of the network node.

After transmitting the groupcast transmission at 1302, the network entity or network node may, in some aspects, identify, based on the network node classes of each of the one or more network nodes, feedback resources based on a corresponding network node class of the one or more network node classes. Identifying the feedback resources may be performed by groupcast feedback resource indication component 199, the application processor 1706, or the cellular baseband processor 1724. As discussed above, feedback resources may be in a subset of feedback resources that is common to all the network node classes such that identifying the feedback resource includes (1) identifying the common subset of feedback resources and (2) identifying a resource in the identified common subset of feedback resources as described above (e.g., based on a modulo operation based on the groupcast ID, the source ID, and an offset vale associated with the network node class over the resources of the common subset of feedback resources). In some aspects, the subset of feedback resources associated with each network node class of the one or more network nodes may be a subset of feedback resources that may be disjoint from subsets of resources that are associated with other network node classes such that identifying the feedback resources may include (1) identifying the subset of resources associated with the network node class of each of the one or more network nodes and (2) identifying a feedback resource within the subset of feedback resources associated with the network node class of the one or more network nodes as described above (e.g., based on a modulo operation based on the groupcast ID and the source ID over the resources of the subset of feedback resources). For example, referring to FIGS. 5 and 7, the network node 504 or the network entity 702 may identify, similar to the network node 506 or 706 at 514 or 714, the feedback resource for groupcast feedback related to groupcast transmission 512 or 712. In some aspects, the feedback resources for the one or more network nodes are identified in order to determine which resources to monitor for feedback.

At 1304, the network entity or network node may receive feedback for the groupcast transmission transmitted at 1302 from the one or more network nodes in one or more feedback resources based on a corresponding network node class of the one or more network nodes. For example, 1304 may be performed by groupcast feedback resource indication component 199, the cellular baseband processor 1724, the transceiver 1722, and/or antenna(s) 1780. The feedback for the groupcast transmission may be one of an ACK or a NACK depending on the feedback mode/configuration, e.g., ACK-only, NACK-only, or ACK/NACK, which may in turn depend on the network node class of the network node from which the feedback is received. For example, referring to FIGS. 5 and 7, network node 504 or network entity 702, may receive groupcast feedback transmission 516 or 716.

If the groupcast feedback transmission received at 1304 indicates that at least one network node of the one or more network nodes failed to decode the groupcast transmission (e.g., that a retransmission is desired), the network entity or network node may retransmit the groupcast transmission. Retransmitting the groupcast transmission may be performed by groupcast feedback resource indication component 199, the cellular baseband processor 1724, the transceiver 1722, and/or antenna(s) 1780. The groupcast feedback transmission, in some aspects, may indicate that a retransmission is desired by including a NACK bit. In some aspects, the feedback received at 1304 may include a skipped ACK-bit transmission by a network node to indicate, by failing to transmit the ACK bit, that a retransmission is desired. For a network node class that is associated with an energy harvesting mode of operation or a low battery level/energy conserving mode of operation, an ACK-only or ACK/NACK feedback configuration may be used. The ACK-only or ACK/NACK feedback configuration may be used to avoid misinterpreting a failure to transmit feedback due to an energy conservation operation (e.g., that prevents and/or preempts feedback transmission or decoding operations) as a failure to transmit feedback due to a successful decoding of the groupcast transmission. For example, referring to FIGS. 5 and 7, the network node 504 or the network entity 702 may transmit groupcast retransmission 518 or 718 to a requesting network node 506 or 706.

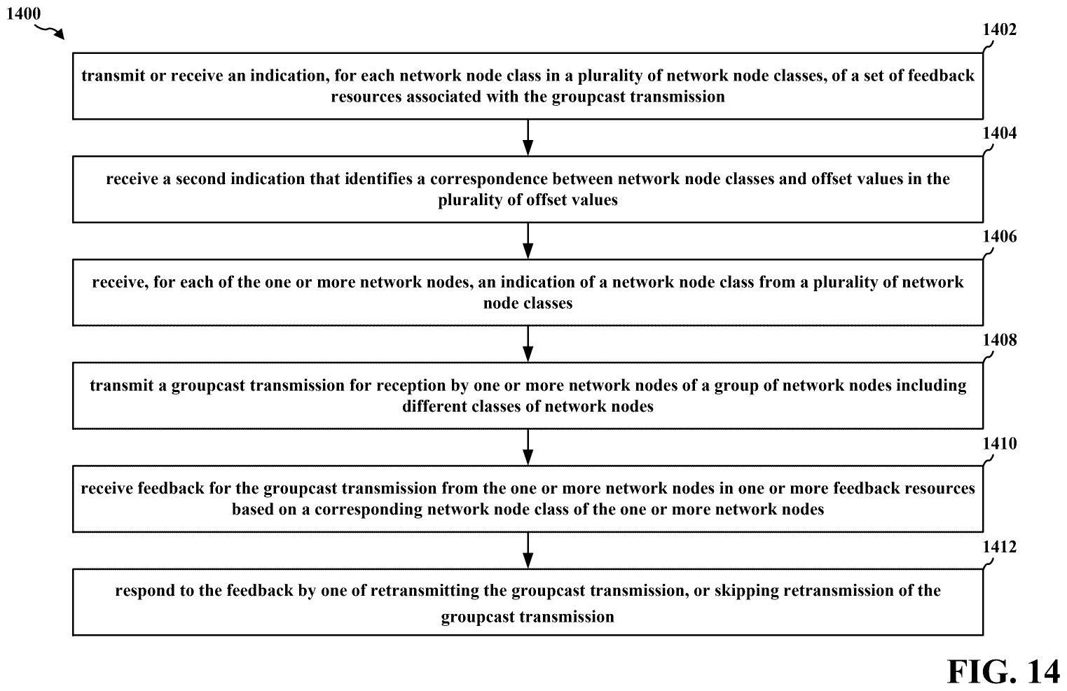

FIG. 14 is a flowchart 1400 of a method of wireless communication. The method may be performed by a network entity or network node (e.g., the UE 104; the BS 102; the network entity, 602, or 702; the network node 504 or 604; the apparatus 1704). At 1402, the network entity or network node may transmit (or receive) an indication, for each network node class in a plurality of network node classes, of a set of feedback resources associated with the groupcast transmission. For example, 1402 may be performed by groupcast feedback resource indication component 199, the cellular baseband processor 1724, the transceiver 1722, and/or antenna(s) 1780. The indication, in some aspects, may include an indication of a first subset of feedback resources for non-energy harvesting network nodes and a second subset of feedback resources for energy harvesting network nodes. In some aspects, the first subset of feedback resources includes one or more resource blocks in a different slot or a different sub-channel than the second subset of resources. The first subset of feedback resources, in some aspects, includes one or more resource blocks that are different than the second subset of feedback resources in a same slot or a same sub-channel as the second subset of feedback resources. For example, referring to FIGS. 5, 7, 9A, 9B, and 20, the network entity 502 or 702 may transmit feedback resource indication 508 or 708 that may indicate the feedback resource subsets 920, 930, 940, 970, 980, 990, 2020, and 2030.

At 1404, the network entity or network node may transmit or receive a second indication that identifies a correspondence between network node classes (e.g., network node class IDs) and offset values in the plurality of offset values. For example, 1404 may be performed by groupcast feedback resource indication component 199, the cellular baseband processor 1724, the transceiver 1722, and/or antenna(s) 1780. In some aspects, the plurality of network node classes includes at least one energy harvesting class. The second indication, in some aspects, may be part of the indication transmitted (or received) at 1402. The offset values, in some aspects, may be used, e.g., by a groupcast destination network node and/or the network entity or network node transmitting the groupcast transmission, to identify a groupcast feedback resource in addition to a groupcast ID and a source ID. The plurality of network node classes, in some aspects, may include network node classes associated with different energy harvesting characteristics of energy harvesting class network nodes. The different energy harvesting characteristics may relate to one or more of a battery level, an energy harvesting rate, or an energy harvesting mode of operation. For example, referring to FIGS. 5, 7, and 8, the network entity 502 or 702 may transmit feedback resource indication 508 or 708 that may indicate the offset values Non_EH_UE_Offset=0, EH_UE_Class 1_Offset=1, and EH_UE_Class 2_Offset=2 for selecting resources in the feedback resource pool 820 that may also be indicated in the feedback resource indication 508 or 708.

At 1406, the network entity or network node, in some aspects, may receive, for each of the one or more (groupcast destination) network nodes, an indication of a network node class from a plurality of network node classes. For example, 1406 may be performed by groupcast feedback resource indication component 199, the cellular baseband processor 1724, the transceiver 1722, and/or antenna(s) 1780. The indication of the network node class for a particular (groupcast destination) network node may be transmitted before or after transmitting the groupcast transmission at 1402. For example, referring to FIGS. 5 and 7, the network node 504, or the network entity 702 may receive from network node 506 or 706 the network node class indication 510 or 710 indicating a network node class of the network node.

At 1408, the network entity or network node may transmit a groupcast transmission for reception by one or more network nodes of a group of network nodes including different classes of network nodes. For example, 1408 may be performed by groupcast feedback resource indication component 199, the cellular baseband processor 1724, the transceiver 1722, and/or antenna(s) 1780. The groupcast transmission transmitted at 1408 may, in some aspects, be associated with a groupcast ID and a source ID corresponding to the network entity node or the network entity transmitting the groupcast transmission at 1408. For example, referring to FIGS. 5, 7, 8, 9A, 9B, and 20, a network node 504 or a network entity 702 may transmit a groupcast transmission 512 or 712 (e.g., via a slot i, in the sub-channel j 810, 910, 960, or 2010).

After transmitting the groupcast transmission at 1408, the network entity or network node may, in some aspects, identify, based on the network node classes of each of the one or more network nodes, feedback resources based on a corresponding network node class of the one or more network node classes. Identifying the feedback resources may be performed by groupcast feedback resource indication component 199, the application processor 1706, or the cellular baseband processor 1724. As discussed above, feedback resources may be in a subset of feedback resources that is common to all the network node classes such that identifying the feedback resource includes (1) identifying the common subset of feedback resources and (2) identifying a resource in the identified common subset of feedback resources as described above (e.g., based on a modulo operation based on the groupcast ID, the source ID, and an offset vale associated with the network node class over the resources of the common subset of feedback resources). In some aspects, the subset of feedback resources associated with each network node class of the one or more network nodes may be a subset of feedback resources that may be disjoint from subsets of resources that are associated with other network node classes such that identifying the feedback resources may include (1) identifying the subset of resources associated with the network node class of each of the one or more network nodes and (2) identifying a feedback resource within the subset of feedback resources associated with the network node class of the one or more network nodes as described above (e.g., based on a modulo operation based on the groupcast ID and the source ID over the resources of the subset of feedback resources). For example, referring to FIGS. 5 and 7, the network node 504 or the network entity 702 may identify, similar to the network node 506 or 706 at 514 or 714, the feedback resource for groupcast feedback related to groupcast transmission 512 or 712. In some aspects, the feedback resources for the one or more network nodes are identified in order to determine which resources to monitor for feedback.

At 1410, the network entity or network node may receive feedback for the groupcast transmission transmitted at 1408 from the one or more network nodes in one or more feedback resources based on a corresponding network node class of the one or more network nodes. For example, 1410 may be performed by groupcast feedback resource indication component 199, the cellular baseband processor 1724, the transceiver 1722, and/or antenna(s) 1780. The feedback for the groupcast transmission may be one of an ACK or a NACK depending on the feedback mode/configuration, e.g., ACK-only, NACK-only, or ACK/NACK, which may in turn depend on the network node class of the network node from which the feedback is received. For example, referring to FIGS. 5 and 7, network node 504 or network entity 702, may receive groupcast feedback transmission 516 or 716.

At 1412, the network entity of network node may respond to the feedback received at 1410. The response, at 1412, may include one of retransmitting the groupcast transmission if the feedback includes a negative acknowledgment that is received in the first subset of feedback resources or skipping retransmission of the groupcast transmission if the feedback is received in the second subset of feedback resources and not in the first subset of feedback resources. For example, 1412 may be performed by groupcast feedback resource indication component 199, the cellular baseband processor 1724, the transceiver 1722, and/or antenna(s) 1780. If the groupcast feedback transmission received at 1410 indicates that at least one network node of the one or more network nodes failed to decode the groupcast transmission (e.g., that a retransmission is desired), the network entity or network node may retransmit the groupcast transmission at 1412. The groupcast feedback transmission received at 1410, in some aspects, may indicate that a retransmission is desired by including a NACK bit. In some aspects, the feedback received at 1410 may include a skipped ACK-bit transmission by a network node to indicate, by failing to transmit the ACK bit, that a retransmission is desired. For a network node class that is associated with an energy harvesting mode of operation or a low battery level/energy conserving mode of operation, an ACK-only or ACK/NACK feedback configuration may be used. The ACK-only or ACK/NACK feedback configuration may be used to avoid misinterpreting a failure to transmit feedback due to an energy conservation operation (e.g., that prevents and/or preempts feedback transmission or decoding operations) as a failure to transmit feedback due to a successful decoding of the groupcast transmission. For example, referring to FIGS. 5 and 7, the network node 504 or the network entity 702 may transmit groupcast retransmission 518 or 718 to a requesting network node 506 or 706.

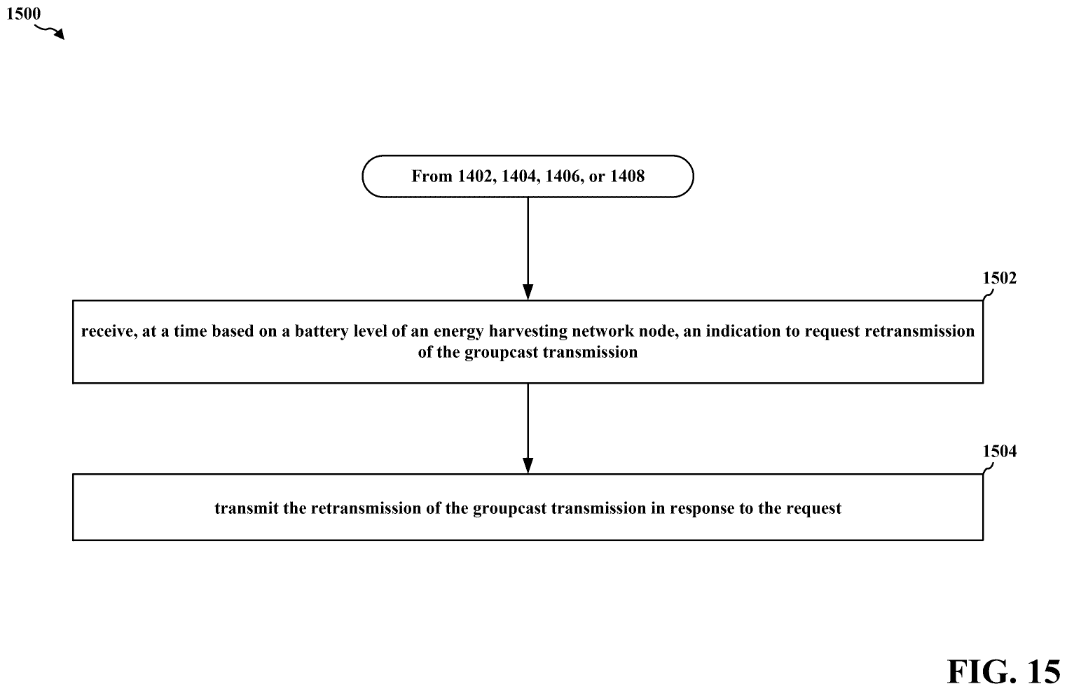

FIG. 15 is a flowchart 1500 of a method of wireless communication. The method may be performed by a network entity or network node (e.g., the UE 104; the BS 102; the network entity, 602, or 702; the network node 504 or 604; the apparatus 1704). The method may be performed after any of the operations 1402, 1404, 1406, or 1408 of FIG. 14 and may be independent of the groupcast transmission transmitted by the network entity or network node at 1302 and the feedback transmitted for the groupcast transmission at 1304 of FIG. 13. At 1502, the network entity or network node may receive, at a time based on a battery level (or network node class) of an energy harvesting network node, an indication to request retransmission of a groupcast transmission. For example, 1502 may be performed by groupcast feedback resource indication component 199, the cellular baseband processor 1724, the transceiver 1722, and/or antenna(s) 1780. The network entity or network node may monitor or identify the resource in which the indication to request retransmission of the groupcast transmission is received at 1502 based on a feedback resource indication (as described in relation to 1402 of FIG. 14) and a network node class (e.g., indicated by a network node class indication as described in relation to 1406 of FIG. 14). For example, referring to FIG. 6A, the network node 604 may receive the request for retransmission indication 616 from network node 606.

In some aspects, the indication to request retransmission of a groupcast transmission may be received at 1502, in response to groupcast transmission control information transmitted by the network entity or network node. The network entity or network node may transmit the control information for the groupcast transmission via MAC-CE, DCI, or SC. The groupcast destination network node that receives the groupcast transmission control information may be operating in an energy harvesting mode of operation and/or an energy conservation mode of operation that prevents and/or preempts feedback transmission or decoding operations based on, e.g., a battery level of the network node or an energy harvesting operation. The groupcast transmission control information may indicate that a groupcast transmission is scheduled for a time (e.g., a slot or set of symbols) during an energy conserving period (e.g., a period during which the network node receiving the groupcast transmission control information may not receive or decode the scheduled groupcast transmission). The groupcast destination network node may identify that the groupcast transmission scheduled by the groupcast transmission control information may not be decoded based on the groupcast transmission being scheduled during the energy conserving period. For example, referring to FIG. 6A, the network node 604 may transmit the groupcast transmission control information 610 to the network node 606.

The network entity or network node may transmit the scheduled groupcast transmission which the groupcast destination network node may not receive and/or decode based on the mode of operation of the groupcast destination network node. For example, referring to FIG. 6A, the network node 604 may transmit the groupcast transmission 612 to the network node 606 during the energy conserving period 613. The network entity or network node may identify a resource associated with a potential retransmission request. The identified resource may be from a set of time (and frequency) resources that are available for transmitting a request for retransmission indication in a monitoring/transmitting period associated with a network node class of at least one groupcast destination network node. The resource for the retransmission request may be identified based on information included in a feedback resource indication as described in relation to 1402 of FIG. 14 and a current network node class associated with the groupcast destination network node as described in relation to 1406 of FIG. 14.

At 1504, the network entity or network node may transmit the retransmission of the groupcast transmission in response to the request (e.g., the indication to request retransmission of a groupcast transmission) received at 1502. For example, 1504 may be performed by groupcast feedback resource indication component 199, the cellular baseband processor 1724, the transceiver 1722, and/or antenna(s) 1780. The retransmission of the groupcast transmission at 1504 may be scheduled during a time that is configured at the groupcast destination network node for reception/transmission based on the network node class associated with the groupcast destination network node. For example, referring to FIG. 6A, the network node 604, may transmit the groupcast retransmission 618 via a resource in a set of time resources during a monitoring/transmitting period 617 that are available for transmitting a request for retransmission indication 616.

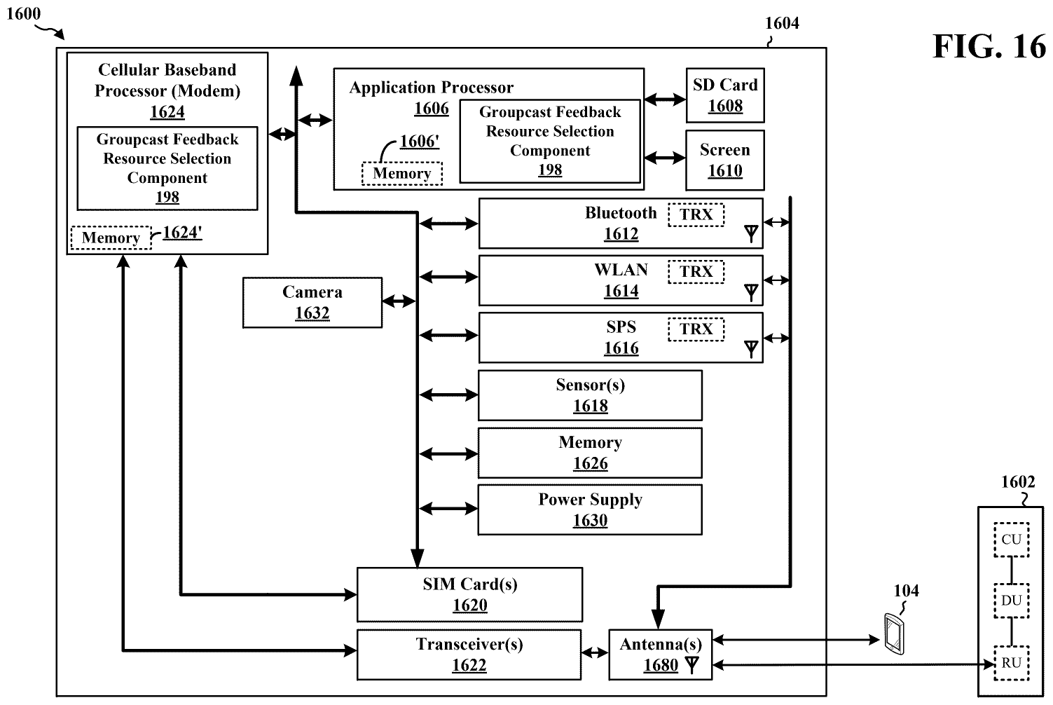

FIG. 16 is a diagram 1600 illustrating an example of a hardware implementation for an apparatus 1604. The apparatus 1604 may be a UE, a component of a UE, or may implement UE functionality. In some aspects, the apparatus 1604 may include a cellular baseband processor 1624 (also referred to as a modem) coupled to one or more transceivers 1622 (e.g., cellular RF transceiver). The cellular baseband processor 1624 may include on-chip memory 1624′. In some aspects, the apparatus 1604 may further include one or more subscriber identity modules (SIM) cards 1620 and an application processor 1606 coupled to a secure digital (SD) card 1608 and a screen 1610. The application processor 1606 may include on-chip memory 1606′. In some aspects, the apparatus 1604 may further include a Bluetooth module 1612, a WLAN module 1614, an SPS module 1616 (e.g., GNSS module), one or more sensor modules 1618 (e.g., barometric pressure sensor/altimeter; motion sensor such as inertial management unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1626, a power supply 1630, and/or a camera 1632. The Bluetooth module 1612, the WLAN module 1614, and the SPS module 1616 may include an on-chip transceiver (TRX) (or in some cases, just a receiver (RX)). The Bluetooth module 1612, the WLAN module 1614, and the SPS module 1616 may include their own dedicated antennas and/or utilize the antennas 1680 for communication. The cellular baseband processor 1624 communicates through the transceiver(s) 1622 via one or more antennas 1680 with the UE 104 and/or with an RU associated with a network entity 1602. The cellular baseband processor 1624 and the application processor 1606 may each include a computer-readable medium/memory 1624′, 1606′, respectively. The additional memory modules 1626 may also be considered a computer-readable medium/memory. Each computer-readable medium/memory 1624′, 1606′, 1626 may be non-transitory. The cellular baseband processor 1624 and the application processor 1606 are each responsible for general processing, including the execution of software stored on the computer-readable medium/memory. The software, when executed by the cellular baseband processor 1624/application processor 1606, causes the cellular baseband processor 1624/application processor 1606 to perform the various functions described supra. The computer-readable medium/memory may also be used for storing data that is manipulated by the cellular baseband processor 1624/application processor 1606 when executing software. The cellular baseband processor 1624/application processor 1606 may be a component of the UE 350 and may include the memory 360 and/or at least one of the TX processor 368, the RX processor 356, and the controller/processor 359. In one configuration, the apparatus 1604 may be a processor chip (modem and/or application) and include just the cellular baseband processor 1624 and/or the application processor 1606, and in another configuration, the apparatus 1604 may be the entire UE (e.g., see 350 of FIG. 3) and include the additional modules of the apparatus 1604.

As discussed supra, the groupcast feedback resource selection component 198 is configured to receive a groupcast transmission and transmit feedback for the groupcast transmission via a feedback resource in a set of feedback resources associated with the groupcast transmission, the feedback resource being based on a network node class of the UE (e.g., a network node). The groupcast feedback resource selection component 198 may be within the cellular baseband processor 1624, the application processor 1606, or both the cellular baseband processor 1624 and the application processor 1606. The groupcast feedback resource selection component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1604 may include a variety of components configured for various functions. In one configuration, the apparatus 1604, and in particular the cellular baseband processor 1624 and/or the application processor 1606, includes means for receiving a groupcast transmission; transmitting feedback for the groupcast transmission via a feedback resource in a set of feedback resources associated with the groupcast transmission, the feedback resource being based on a network node class of the network node; receiving an indication, for each network node class in a plurality of network node classes including at least one energy harvesting class, a subset of feedback resources associated with the groupcast transmission; selecting, based on the network node class of the network node, the feedback resource from the subset of feedback resources associated with the network node class of the network node; receiving an indication that identifies a correspondence between network node classes and offset values in the plurality of offset values; receiving control information for a second groupcast transmission; transmitting an indication to request retransmission of the second groupcast transmission at a time based on a battery level of the network node; and transmitting an indication of a network node class of the network node. The means may be the groupcast feedback resource selection component 198 of the apparatus 1604 configured to perform the functions recited by the means. As described supra, the apparatus 1604 may include the TX processor 368, the RX processor 356, and the controller/processor 359. As such, in one configuration, the means may be the TX processor 368, the RX processor 356, and/or the controller/processor 359 configured to perform the functions recited by the means.

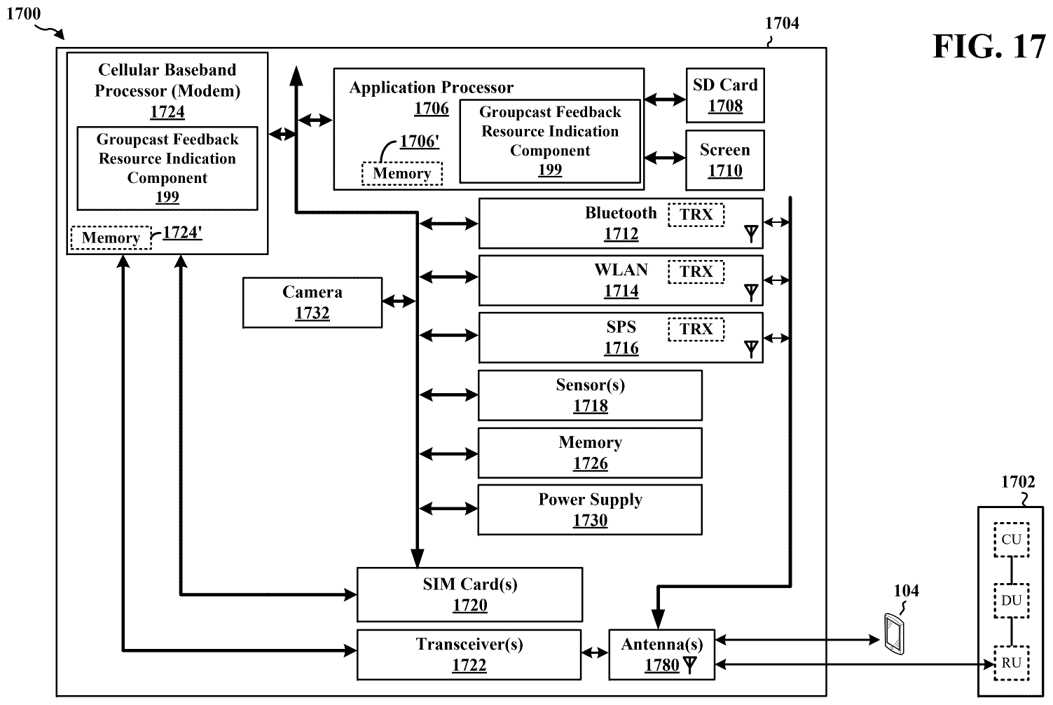

FIG. 17 is a diagram 1700 illustrating an example of a hardware implementation for an apparatus 1704. The apparatus 1704 may be a UE, a component of a UE, or may implement UE functionality. In some aspects, the apparatus 1704 may include a cellular baseband processor 1724 (also referred to as a modem) coupled to one or more transceivers 1722 (e.g., cellular RF transceiver). The cellular baseband processor 1724 may include on-chip memory 1724′. In some aspects, the apparatus 1704 may further include one or more subscriber identity modules (SIM) cards 1720 and an application processor 1706 coupled to a secure digital (SD) card 1708 and a screen 1710. The application processor 1706 may include on-chip memory 1706′. In some aspects, the apparatus 1704 may further include a Bluetooth module 1712, a WLAN module 1714, an SPS module 1716 (e.g., GNSS module), one or more sensor modules 1718 (e.g., barometric pressure sensor/altimeter; motion sensor such as inertial management unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1726, a power supply 1730, and/or a camera 1732. The Bluetooth module 1712, the WLAN module 1714, and the SPS module 1716 may include an on-chip transceiver (TRX) (or in some cases, just a receiver (RX)). The Bluetooth module 1712, the WLAN module 1714, and the SPS module 1716 may include their own dedicated antennas and/or utilize the antennas 1780 for communication. The cellular baseband processor 1724 communicates through the transceiver(s) 1722 via one or more antennas 1780 with the UE 104 and/or with an RU associated with a network entity 1702. The cellular baseband processor 1724 and the application processor 1706 may each include a computer-readable medium/memory 1724′, 1706′, respectively. The additional memory modules 1726 may also be considered a computer-readable medium/memory. Each computer-readable medium/memory 1724′, 1706′, 1726 may be non-transitory. The cellular baseband processor 1724 and the application processor 1706 are each responsible for general processing, including the execution of software stored on the computer-readable medium/memory. The software, when executed by the cellular baseband processor 1724/application processor 1706, causes the cellular baseband processor 1724/application processor 1706 to perform the various functions described supra. The computer-readable medium/memory may also be used for storing data that is manipulated by the cellular baseband processor 1724/application processor 1706 when executing software. The cellular baseband processor 1724/application processor 1706 may be a component of the UE 350 and may include the memory 360 and/or at least one of the TX processor 368, the RX processor 356, and the controller/processor 359. In one configuration, the apparatus 1704 may be a processor chip (modem and/or application) and include just the cellular baseband processor 1724 and/or the application processor 1706, and in another configuration, the apparatus 1704 may be the entire UE (e.g., see 350 of FIG. 3) and include the additional modules of the apparatus 1704.

As discussed supra, the groupcast feedback resource indication component 199 is configured to transmit a groupcast transmission for reception by one or more network nodes of a group of network nodes including different classes of network nodes and receive feedback for the groupcast transmission from the one or more network nodes in one or more feedback resources based on a corresponding network node class of the one or more network nodes. The groupcast feedback resource indication component 199 may be within the cellular baseband processor 1724, the application processor 1706, or both the cellular baseband processor 1724 and the application processor 1706. The groupcast feedback resource indication component 199 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1704 may include a variety of components configured for various functions. In one configuration, the apparatus 1704, and in particular the cellular baseband processor 1724 and/or the application processor 1706, includes means for transmitting a groupcast transmission for reception by one or more network nodes of a group of network nodes including different classes of network nodes; receiving feedback for the groupcast transmission from the one or more network nodes in one or more feedback resources based on a corresponding network node class of the one or more network nodes; retransmitting the groupcast transmission if the feedback includes a negative acknowledgment that is received in the first subset of feedback resources; skipping retransmission of the groupcast transmission if the feedback is received in the second subset of feedback resources and not in the first subset of feedback resources; receiving, for each of the one or more network nodes, an indication of a network node class from a plurality of network node classes; transmitting an indication, for each network node class in a plurality of network node classes, of a set of feedback resources associated with the groupcast transmission; receiving the indication; transmitting or receiving a second indication that identifies a correspondence between network node classes and offset values in the plurality of offset values; receiving, at a time based on a battery level of an energy harvesting network node, an indication to request retransmission of the groupcast transmission; transmitting the retransmission of the groupcast transmission in response to the request. The means may be the component 199 of the apparatus 1704 configured to perform the functions recited by the means. As described supra, the apparatus 1704 may include the TX processor 368, the RX processor 356, and the controller/processor 359. As such, in one configuration, the means may be the TX processor 368, the RX processor 356, and/or the controller/processor 359 configured to perform the functions recited by the means.

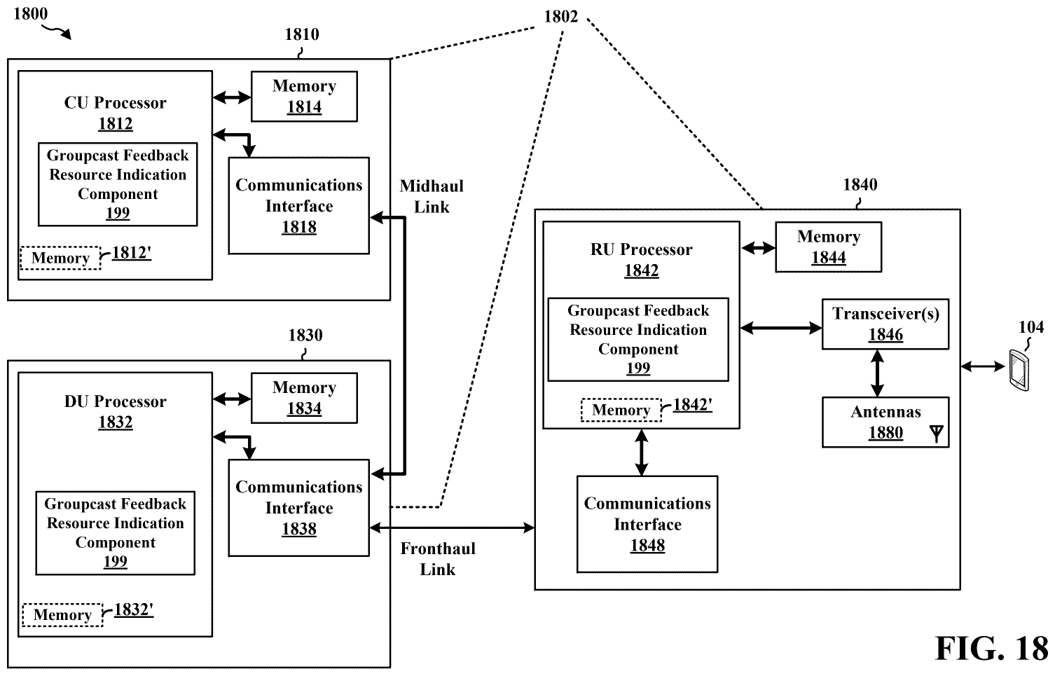

FIG. 18 is a diagram 1800 illustrating an example of a hardware implementation for a network entity 1802. The network entity 1802 may be a BS, a component of a BS, or may implement BS functionality. The network entity 1802 may include at least one of a CU 1810, a DU 1830, or an RU 1840. For example, depending on the layer functionality handled by the component 199, the network entity 1802 may include the CU 1810; both the CU 1810 and the DU 1830; each of the CU 1810, the DU 1830, and the RU 1840; the DU 1830; both the DU 1830 and the RU 1840; or the RU 1840. The CU 1810 may include a CU processor 1812. The CU processor 1812 may include on-chip memory 1812′. In some aspects, the CU 1810 may further include additional memory modules 1814 and a communications interface 1818. The CU 1810 communicates with the DU 1830 through a midhaul link, such as an F1 interface. The DU 1830 may include a DU processor 1832. The DU processor 1832 may include on-chip memory 1832′. In some aspects, the DU 1830 may further include additional memory modules 1834 and a communications interface 1838. The DU 1830 communicates with the RU 1840 through a fronthaul link. The RU 1840 may include an RU processor 1842. The RU processor 1842 may include on-chip memory 1842′. In some aspects, the RU 1840 may further include additional memory modules 1844, one or more transceivers 1846, antennas 1880, and a communications interface 1848. The RU 1840 communicates with the UE 104. The on-chip memory 1812′, 1832′, 1842′ and the additional memory modules 1814, 1834, 1844 may each be considered a computer-readable medium/memory. Each computer-readable medium/memory may be non-transitory. Each of the processors 1812, 1832, 1842 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the groupcast feedback resource indication component 199 is configured to transmit a groupcast transmission for reception by one or more network nodes of a group of network nodes including different classes of network nodes and receive feedback for the groupcast transmission from the one or more network nodes in one or more feedback resources based on a corresponding network node class of the one or more network nodes. The groupcast feedback resource indication component 199 may be within one or more processors of one or more of the CU 1810, DU 1830, and the RU 1840. The groupcast feedback resource indication component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1802 may include a variety of components configured for various functions. In one configuration, the network entity 1802 includes means for transmitting a groupcast transmission for reception by one or more network nodes of a group of network nodes including different classes of network nodes; receiving feedback for the groupcast transmission from the one or more network nodes in one or more feedback resources based on a corresponding network node class of the one or more network nodes; retransmitting the groupcast transmission if the feedback includes a negative acknowledgment that is received in the first subset of feedback resources; skipping retransmission of the groupcast transmission if the feedback is received in the second subset of feedback resources and not in the first subset of feedback resources; receiving, for each of the one or more network nodes, an indication of a network node class from a plurality of network node classes; transmitting an indication, for each network node class in a plurality of network node classes, of a set of feedback resources associated with the groupcast transmission; receiving the indication; transmitting or receiving a second indication that identifies a correspondence between network node classes and offset values in the plurality of offset values; receiving, at a time based on a battery level of an energy harvesting network node, an indication to request retransmission of the groupcast transmission; transmitting the retransmission of the groupcast transmission in response to the request. The means may be the groupcast feedback resource indication component 199 of the network entity 1802 configured to perform the functions recited by the means. As described supra, the network entity 1802 may include the TX processor 316, the RX processor 370, and the controller/processor 375. As such, in one configuration, the means may be the TX processor 316, the RX processor 370, and/or the controller/processor 375 configured to perform the functions recited by the means.

In some aspects of wireless communication, groupcast transmissions may be transmitted by a network entity or network node for reception by one or more network nodes of a group of network nodes including different classes of network nodes. The groupcast transmission may be transmitted via sidelink communication (e.g., V2X, a PC5 interface) or a downlink transmission (e.g., via a Uu interface). In some aspects, feedback for a groupcast transmission may be configured as NACK-only feedback (e.g., groupcast option 1). For both sidelink and downlink groupcast transmissions, receiving network nodes may transmit feedback (HARQ feedback) via a same set of resources (e.g., based on a groupcast ID and source ID associated with a groupcast transmission).

In aspects using NACK-only feedback, there may be challenges distinguishing between a lack of NACK feedback based on a successful decoding of a groupcast transmission and a lack of NACK feedback based on a receiving network node not having sufficient energy (e.g., when operating in an energy harvesting mode of operation). There may be a benefit to distinguishing feedback from a set of network nodes not performing an energy harvesting operation (e.g., network nodes with sufficient energy to transmit groupcast feedback or legacy network nodes incapable of performing an energy harvesting operation) and a set of network nodes performing energy harvesting operations (e.g., associated with different battery levels). Additionally, the disclosure provides a method that allows a groupcast transmission to be communicated to network nodes that may be in power-saving or RedCap modes of operation during an initial groupcast transmission.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE, including receiving a groupcast transmission and transmitting feedback for the groupcast transmission via a feedback resource in a set of feedback resources associated with the groupcast transmission, the feedback resource being based on a network node class of the network node.

Aspect 2 is the method of aspect 1, where the set of feedback resources associated with the groupcast transmission includes a first subset of feedback resources for non-energy harvesting network nodes and a second subset of feedback resources for energy harvesting network nodes.

Aspect 3 is the method of aspect 2, where the first subset of feedback resources includes one or more resource blocks in a different slot or a different sub-channel than the second subset of resources.

Aspect 4 is the method of any of aspects 2 and 3, where the first subset of feedback resources includes one or more resource blocks in a different slot or a different sub-channel than the second subset of resources.

Aspect 5 is the method of any of aspects 1 to 4, further including receiving an indication, for each network node class in a plurality of network node classes including at least one energy harvesting class, a subset of feedback resources associated with the groupcast transmission; and selecting, based on the network node class of the network node, the feedback resource from the subset of feedback resources associated with the network node class of the network node.

Aspect 6 is the method of aspect 5, where the plurality of network node classes includes network node classes associated with different energy harvesting characteristics of energy harvesting class network nodes.

Aspect 7 is the method of any of aspects 5 and 6, where the indication is received via RRC signaling.

Aspect 8 is the method of any of aspects 1 to 7, where the feedback resource in which the feedback is transmitted is further based on a network node class identifier associated with the groupcast transmission.

Aspect 9 is the method of any of aspects 1 to 8, where the groupcast transmission is associated with a source ID and a groupcast ID, and the feedback resource is based on the source ID, the groupcast ID, and the network node class of the network node.

Aspect 10 is the method of aspect 9, where the feedback resource is based on the source ID, the groupcast ID, and an offset value from a plurality of offset values associated with different energy harvesting classes.

Aspect 11 is the method of aspect 10, further including receiving an indication that identifies a correspondence between network node classes and offset values in the plurality of offset values.

Aspect 12 is the method of any of aspects 9 to 11, where the groupcast ID and the source ID are independent of the network node class of the network node.

Aspect 13 is the method of any of aspects 1 to 12, where the feedback includes one of an ACK for an ACK-only feedback configuration, or one of the ACK or a NACK for an ACK/NACK feedback configuration.

Aspect 14 is the method of any of aspects 1 to 13, further including receiving control information for a second groupcast transmission and transmitting an indication to request retransmission of the second groupcast transmission at a time based on a battery level of the network node.

Aspect 15 is the method of any of aspects 1 to 14, further including transmitting an indication of the network node class of the network node.

Aspect 16 is a method of wireless communication at a UE, including transmitting a groupcast transmission for reception by one or more network nodes of a group of network nodes including different classes of network nodes and receiving feedback for the groupcast transmission from the one or more network nodes in one or more feedback resources based on a corresponding network node class of the one or more network nodes.

Aspect 17 is the method of aspect 16, where the different classes of network nodes comprise network node classes associated with different energy harvesting characteristics.

Aspect 18 is the method of any of aspects 16 and 17, where a set of feedback resources associated with the groupcast transmission includes a first subset of feedback resources for non-energy harvesting network nodes and a second subset of feedback resources for energy harvesting network nodes.

Aspect 19 is the method of aspect 18, further including retransmitting the groupcast transmission if the feedback includes a negative acknowledgment that is received in the first subset of feedback resources or skipping retransmission of the groupcast transmission if the feedback is received in the second subset of feedback resources and not in the first subset of feedback resources the first subset of feedback resources includes one or more resource blocks in a different slot or a different sub-channel than the second subset of resources.

Aspect 20 is the method of any of aspects 18 and 19, where the first subset of feedback resources includes one or more resource blocks in a different slot or a different sub-channel than the second subset of resources.

Aspect 21 is the method of any of aspects 18 and 19, where the first subset of feedback resources includes one or more resource blocks that are different than the second subset of feedback resources in a same slot or a same sub-channel as the second subset of feedback resources.

Aspect 22 is the method of any of aspects 16 to 21, further including receiving, for each of the one or more network nodes, an indication of a network node class from a plurality of network node classes.

Aspect 23 is the method of any of aspects 16 to 22, further including transmitting an indication, for each network node class in a plurality of network node classes, of a set of feedback resources associated with the groupcast transmission; or receiving the indication, where the one or more feedback resources are based on the indication and the corresponding network node class of the one or more network nodes.

Aspect 24 is the method of aspect 23, where the indication is received via RRC signaling.

Aspect 25 is the method of any of aspects 23 and 24, where the groupcast transmission is associated with a source ID and a groupcast ID, and the one or more feedback resources are based on the source ID, the groupcast ID, and the corresponding network node class of the one or more network nodes.

Aspect 26 is the method of aspect 25, where the one or more feedback resources are based on the source ID, the groupcast ID, and an offset value from a plurality of offset values associated with the corresponding network node class of the one or more network nodes.

Aspect 27 is the method of aspect 26, further including one of transmitting or receiving a second indication that identifies a correspondence between network node classes and offset values in the plurality of offset values.

Aspect 28 is the method of any of aspects 25 to 27, where the groupcast ID and the source ID are independent of the corresponding network node class of the one or more network nodes.

Aspect 29 is the method of any of aspects 16-28, where a first network node class of the one or more network nodes is associated with a first network node performing an energy-harvesting operation and a second network node class of the one or more network nodes is associated with a second network node not performing an energy harvesting operation, and where for the first network node class, the feedback is one of: an ACK for an ACK-only feedback configuration, or one of the ACK or a NACK for an ACK/NACK feedback configuration, and for the second network node class, the feedback is the NACK for a NACK-only feedback configuration.

Aspect 30 is the method of any of aspects 16 to 29 further including receiving, at a time based on a battery level of an energy harvesting network node, an indication to request retransmission of the groupcast transmission and transmitting the retransmission of the groupcast transmission in response to the indication to request the retransmission of the groupcast transmission.

Aspect 31 is an apparatus for implementing the method of any of aspects 1 to 30.

Aspect 32 is an apparatus for wireless communication including means for implementing any of aspects 1 to 30.

Aspect 33 is a computer-readable medium storing computer executable code, where the code when executed by a processor causes the processor to implement any of aspects 1 to 30.

What is claimed is:

1. A method for wireless communication at a network node, comprising:
receiving a groupcast transmission; and
transmitting feedback for the groupcast transmission via a feedback resource in a set of feedback resources associated with the groupcast transmission, the feedback resource being based on a network node class of the network node.

2. The method of claim 1, wherein the set of feedback resources associated with the groupcast transmission includes a first subset of feedback resources for non-energy harvesting network nodes and a second subset of feedback resources for energy harvesting network nodes.

3. The method of claim 2, wherein the first subset of feedback resources includes one or more resource blocks in a different slot or a different sub-channel than the second subset of resources.

4. The method of claim 2, wherein the first subset of feedback resources includes one or more resource blocks that are different than the second subset of feedback resources in a same slot or a same sub-channel as the second subset of feedback resources.

5. The method of claim 1, further comprising:
receiving an indication, for each network node class in a plurality of network node classes including at least one energy harvesting class, a subset of feedback resources associated with the groupcast transmission; and
selecting, based on the network node class of the network node, the feedback resource from the subset of feedback resources associated with the network node class of the network node.

6. The method of claim 5, wherein the plurality of network node classes comprises network node classes associated with different energy harvesting characteristics of energy harvesting class network nodes.

7. The method of claim 5, wherein the indication is received via radio resource control (RRC) signaling.

8. The method of claim 1, wherein the feedback resource in which the feedback is transmitted is further based on a network node class identifier associated with the groupcast transmission.

9. The method of claim 1, wherein the groupcast transmission is associated with a source identifier (ID) and a groupcast ID, and the feedback resource is based on the source ID, the groupcast ID, and the network node class of the network node.

10. The method of claim 9, wherein the feedback resource is based on the source ID, the groupcast ID, and an offset value from a plurality of offset values associated with different energy harvesting classes.

11. The method of claim 10, further comprising receiving an indication that identifies a correspondence between network node classes and offset values in the plurality of offset values.

12. The method of claim 9, wherein the groupcast ID and the source ID are independent of the network node class of the network node.

13. The method of claim 1, wherein the feedback includes one of:
an acknowledgment (ACK) for an ACK-only feedback configuration, or
one of the ACK or a negative ACK (NACK) for an ACK/NACK feedback configuration.

14. The method of claim 1, further comprising:
receiving control information for a second groupcast transmission; and
transmitting an indication to request retransmission of the second groupcast transmission at a time based on a battery level of the network node.

15. The method of claim 1, further comprising:
transmitting an indication of the network node class of the network node.

16. A method for wireless communication at a network entity, comprising:
transmitting a groupcast transmission for reception by one or more network nodes of a group of network nodes including different classes of network nodes; and
receiving feedback for the groupcast transmission from the one or more network nodes in one or more feedback resources based on a corresponding network node class of the one or more network nodes.

17. The method of claim 16, wherein the different classes of network nodes comprise network node classes associated with different energy harvesting characteristics.

18. The method of claim 16, wherein a set of feedback resources associated with the groupcast transmission includes a first subset of feedback resources for non-energy harvesting network nodes and a second subset of feedback resources for energy harvesting network nodes.

19. The method of claim 18, further comprising:
retransmitting the groupcast transmission if the feedback includes a negative acknowledgment that is received in the first subset of feedback resources; or
skipping retransmission of the groupcast transmission if the feedback is received in the second subset of feedback resources and not in the first subset of feedback resources.

20. The method of claim 18, wherein the first subset of feedback resources includes one or more resource blocks in a different slot or a different sub-channel than the second subset of resources.

21. The method of claim 18, wherein the first subset of feedback resources includes one or more resource blocks that are different than the second subset of feedback resources in a same slot or a same sub-channel as the second subset of feedback resources.

22. The method of claim 16, further comprising:
receiving, for each of the one or more network nodes, an indication of a network node class from a plurality of network node classes.

23. The method of claim 16, further comprising one of:
transmitting an indication, for each network node class in a plurality of network node classes, of a set of feedback resources associated with the groupcast transmission; or
receiving the indication,
wherein the one or more feedback resources are based on the indication and the corresponding network node class of the one or more network nodes.

24. The method of claim 23, wherein the indication is received via radio resource control (RRC) signaling.

25. The method of claim 23, wherein the groupcast transmission is associated with a source identifier (ID) and a groupcast ID, and the one or more feedback resources are based on the source ID, the groupcast ID, and the corresponding network node class of the one or more network nodes.

26. The method of claim 25, wherein the one or more feedback resources are based on the source ID, the groupcast ID, and an offset value from a plurality of offset values associated with the corresponding network node class of the one or more network nodes.

27. The method of claim 26, further comprising one of transmitting or receiving a second indication that identifies a correspondence between network node classes and offset values in the plurality of offset values.

28. The method of claim 25, wherein the groupcast ID and the source ID are independent of the corresponding network node class of the one or more network nodes.

29. The method of claim 16, wherein a first network node class of the one or more network nodes is associated with a first network node performing an energy-harvesting operation and a second network node class of the one or more network nodes is associated with a second network node not performing an energy harvesting operation, and wherein:
for the first network node class, the feedback is one of:
an acknowledgment (ACK) for an ACK-only feedback configuration, or
one of the ACK or a negative ACK (NACK) for an ACK/NACK feedback configuration, and
for the second network node class, the feedback is the NACK for a NACK-only feedback configuration.

30. The method of claim 16, further comprising:
receiving, at a time based on a battery level of an energy harvesting network node, an indication to request retransmission of the groupcast transmission; and
transmitting the retransmission of the groupcast transmission in response to the indication to request the retransmission of the groupcast transmission.
